(19) United States
(12) Patent Application Publication
(10) Pub. No.: US 2011/0147167 A1
(43) Pub. Date: Jun. 23, 2011

(54) Under-Mount Slat Conveyor

(76) Inventor: David W. Lutz, Carlisle, PA (US)

(21) Appl. No.: 12/886,645

(22) Filed: Sep. 21, 2010

Related U.S. Application Data
(60) Provisional application No. 61/244,159, filed on Sep. 21, 2009.

(51) Int. Cl. B65G 25/04

(52) U.S. Cl. 198/750.4; 198/750.5

(57) ABSTRACT

A reciprocating slat conveyor includes a plurality of slats arranged in a plurality of slat sets, with each slat having a receiving element. A cross-beam assembly is connected to the slats, wherein the cross-beam assembly includes a plurality of linear members. One cross-beam is connected to at least one linear member. Each cross-beam includes a plurality of connecting elements configured to engage the receiving elements on the slats. A plurality of bearing guides are configured to guide the linear members. An under-mount drive assembly of the conveyor comprises a plurality of cylinders, with each piston rod connected to a linear member.

### CROSS REFERENCE TO RELATED APPLICATION

This application claims priority to U.S. Provisional Application No. 61/244,159, filed Sep. 21, 2009, which application is herein incorporated by reference in its entirety. This application is also related to U.S. application Ser. No. 12/793,744, filed Jun. 4, 2010, which is also herein incorporated by reference in its entirety.

### BACKGROUND OF THE INVENTION

1. Field of the Invention

This invention relates generally to reciprocating slat conveyors for loading or unloading cargo from a receptacle and, more particularly, to reciprocating slat conveyors having multiple sets of slats, e.g., two or more sets, incorporating biasing means to preferentially bias cargo on the conveyor during movement of the slats.

2. Technical Considerations

Conventional reciprocating slat conveyors are used for loading and unloading receptacles with bulk cargo, such as garbage, fertilizer, wood chips, sawdust, and the like. The receptacles can be mobile, such as a conventional truck trailer, or fixed in place. The conveyor floor includes sets of slats having individual slats spaced across the width of the receptacle. A hydraulic drive having hydraulic cylinders is typically positioned in the middle of the conveyor floor to move the slats. The cylinders can be actuated to move the slats simultaneously to load or unload the receptacle or to move the sets of slats sequentially to retract the sets of the slats back to the starting position.

These conventional mid-drive slat conveyors typically include three sets of moveable slats. When retracting the slats, only one of the three sets of slats is retracted at a time. The other two sets of slats remain stationary. Therefore, since two-thirds of the conveyor surface area remains stationary while one-third of the conveyor surface area moves, the cargo tends to remain in place and is not moved forwardly (back towards its original starting position). That is one reason why most conventional slat conveyors require at least three sets of slats.

A problem with these conventional mid-drive slat conveyors is that the lateral torque absorbed in the cylinder rods can damage the rods or cause the screws connecting the rods to the slats to wear. The rods are rigidly connected to the slats and any torque caused by misalignment of the slat is transferred to the cylinders and rods. Another problem with these previous systems is that the components were specialized and difficult to service.

In order to alleviate some of the problems associated with mid-drive slat conveyors, front-drive slat conveyors have been developed. Examples of front-drive slat conveyors are disclosed, for example, in U.S. Pat. Nos. 5,402,878 and 5,522,494. While these front-drive conveyors provide some advantages over the prior mid-drive conveyors, additional improvements could be made to even further improve these conventional slat conveyors. For example, it would be advantageous to provide a two-set slat conveyor that would be less complex and less costly than a conventional three-set slat conveyor but that still biases the cargo during movement of one of the slat sets. It would be advantageous to provide a three-step slat conveyor that overcomes at least some of the problems associated with prior three-set slat conveyors. It would be advantageous to provide a conveyor system that utilizes standard, i.e., non-specialized, components and that is easier to service and maintain than prior conveyors.

### SUMMARY OF THE INVENTION

A reciprocating slat conveyor comprises a plurality of slats arranged in a plurality of slat sets, with each slat having a receiving element. A cross-beam assembly is connected to the slats, wherein the cross-beam assembly includes a plurality of linear members. One cross-beam is connected to at least one linear member. Each cross-beam includes a plurality of connecting elements configured to engage the receiving elements on the slats. A plurality of bearing guides are configured to guide the linear members. An under-mount drive assembly of the conveyor comprises a plurality of cylinders, with each piston rod connected to a linear member by a non-alignment critical connector.

A reciprocating slat conveyor comprises a plurality of slats arranged in a plurality of slat sets, with each slat having a receiving element. A cross-beam assembly is connected to the slats, wherein the cross-beam assembly includes a plurality of linear members. One cross-beam is connected to at least one linear member. Each cross-beam includes a plurality of connecting elements configured to engage the receiving elements on the slats. The slats are slidably engaged with plastic bearing elements and the bearing elements include a slot through which the slat receiving elements are connected to the cross-beam connecting elements. A plurality of bearing guides are configured to guide the linear members. An under-mount drive assembly comprises a plurality of hydraulic cylinders, wherein each cylinder is connected to a vehicle frame by a non-alignment critical connector, and wherein each piston rod is connected to a linear member by a non-alignment critical connector.

A deck assembly comprises longitudinal support beams, with each support beam having an exterior profile. Plastic bearing sleeves have an interior profile complementary to at least a portion of the exterior profile of the support beam and are slidable along the support beam. Slats having an interior profile complementary to at least a portion of the outer profile of the bearing sleeve are configured to slide along the bearing sleeve. Each slat has a channel on one side and a groove on an opposite side. A flexible member has a first end that engages the channel on one slat and a second end that extends into the groove on an adjacent slat. The second end of the flexible member includes an angled portion that contacts an upwardly facing surface of the groove.

### BRIEF DESCRIPTION OF THE DRAWINGS

Examples of the invention are shown in the accompanying drawing figures wherein like reference numbers identify like parts throughout.

FIGS. 1-17 show a two-step slat conveyor incorporating features of the invention;

FIGS. 18-34 show a three-step slat conveyor similar to that shown in FIGS. 1-17 incorporating features of the invention;

FIGS. 35-38 show another two-step slat conveyor of the invention;

FIG. 39 shows a further two-step slat conveyor of the invention;

FIG. 40 is a bottom, perspective view of a drive assembly of the invention;

FIG. 41 is a top perspective view of the drive assembly of FIG. 40;

FIG. 42 is a perspective, broken-away view of the drive assembly of FIG. 41 in a trailer;

FIG. 43 is a side view of a hydraulic control assembly illustrating some control features of the invention;

FIG. 44 is a bottom view of another drive assembly of the invention;

FIG. 45 is a top perspective view of the drive assembly of FIG. 44;

FIG. 46 is a side view of the drive assembly of FIG. 45 that also illustrates control features of the invention;

FIG. 47 is a cross-sectional view of a deck assembly of the invention;

FIG. 48 is a cross-sectional view of a another deck assembly of the invention;

FIG. 49 is a cross-sectional view of a leak-resistant deck assembly incorporating features of the invention;

FIG. 50 is a top perspective view of a partial deck assembly incorporating features of the invention;

FIG. 51 is a plan view of a leak resistant deck assembly of FIG. 50;

FIG. 52 is a rear sectional view of a portion of the leak resistant deck assembly of FIG. 51 taken along the line A-A;

FIG. 53 is a rear sectional view of the leak resistant deck assembly of FIG. 51 taken along the lines D-D; and

FIGS. 54 and 55 are bottom perspective views of a drive assembly of the invention incorporating quick-release fittings.

### DESCRIPTION OF THE PREFERRED EMBODIMENTS

As used herein, spatial or directional terms, such as “top,” “bottom,” “left,” “right,” “over,” “under,” “front,” “rear,” and the like, relate to the invention as it is shown in the drawing figures. However, it is to be understood that the invention can assume various alternative orientations, and, accordingly, such terms are not to be considered as limiting. Further, all numbers expressing dimensions, physical characteristics, and so forth, used in the specification, figures, and claims are to be understood as being modified in all instances by the term “about.” Accordingly, unless indicated to the contrary, the numerical values set forth in the following specification, figures, and claims can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. The dimensions set forth on the accompanying drawing figures are for one exemplary embodiment of the invention and it is to be understood that the invention is not limited to the specifically disclosed dimensions.

The present invention provides improvements over known slat conveyors. For example, the bearing guides and related components help reduce the torque and wear problems associated with known slat conveyors. Also, incorporation of biasing means on the slats or in the conveyor system allows for a two-step (i.e., two-set) conveyor system that is less mechanically complex and less costly than the known three-set conveyors.

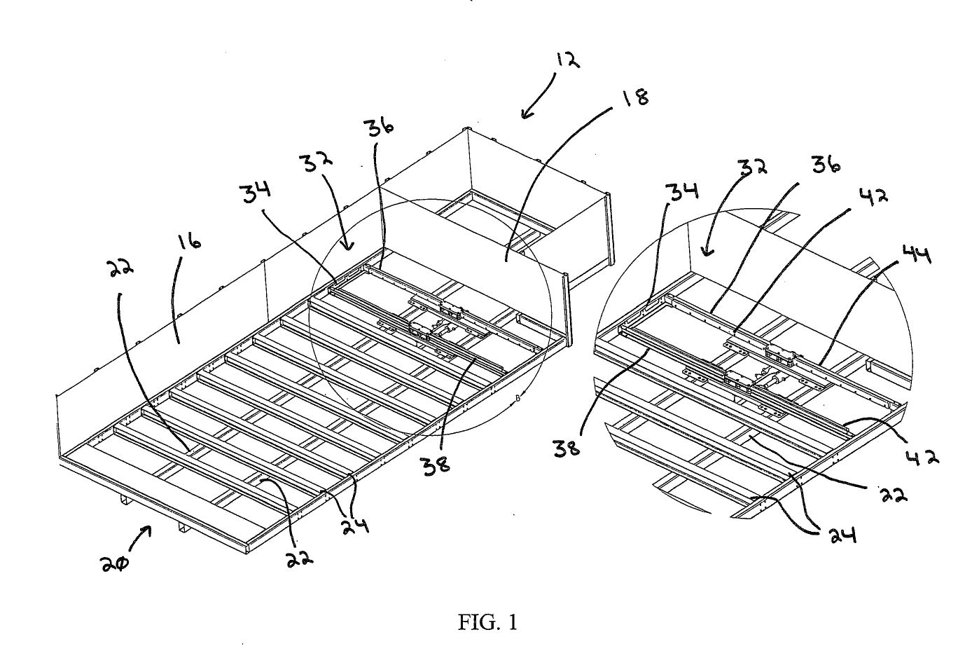

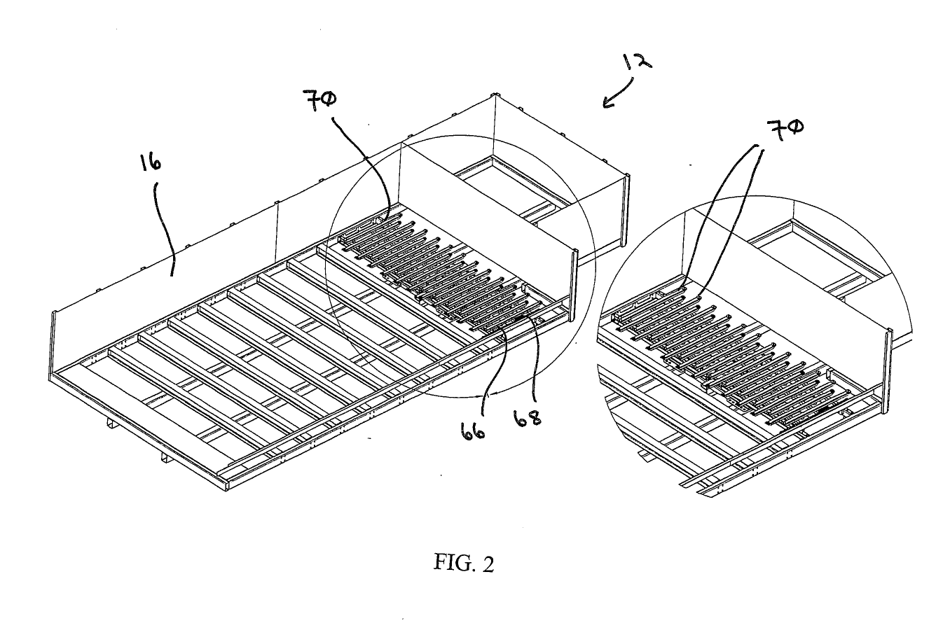

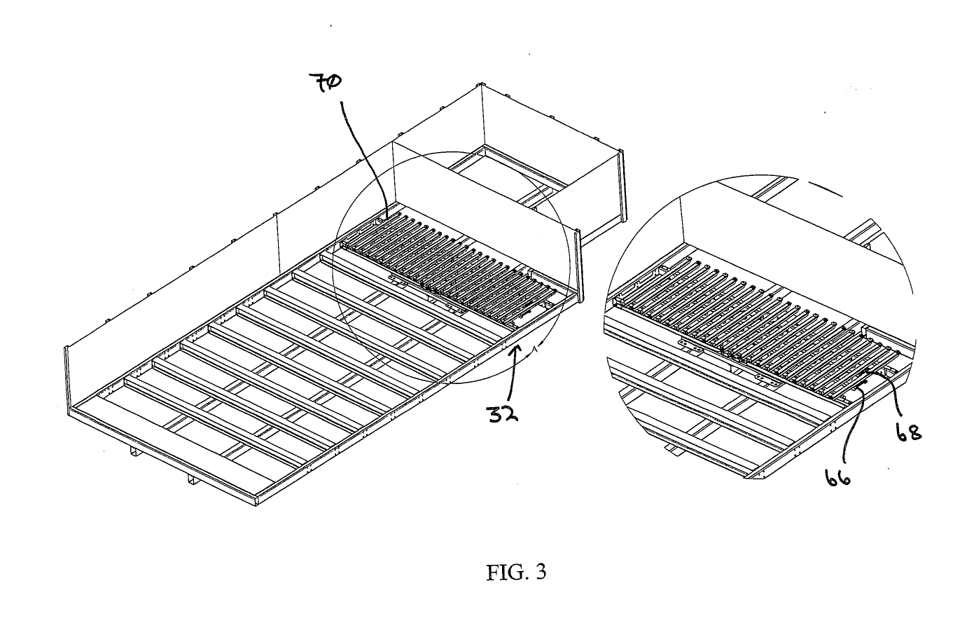

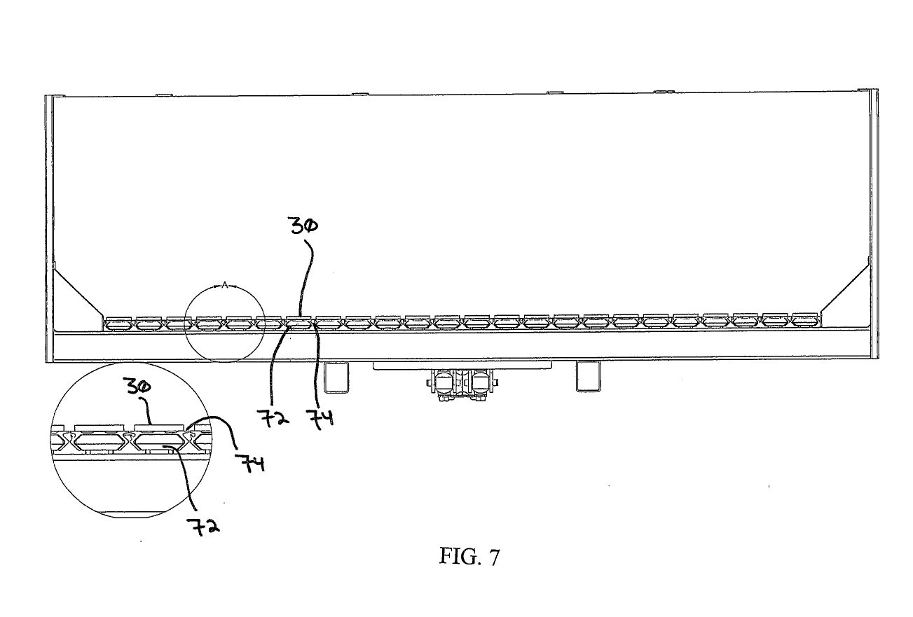

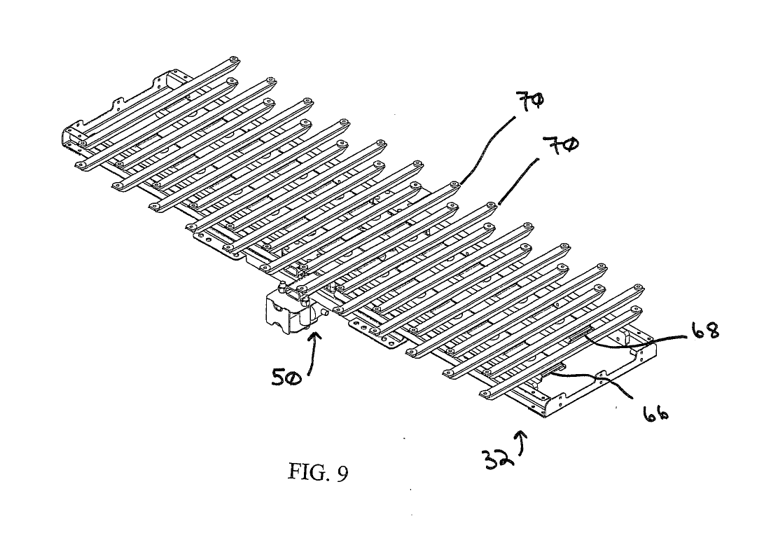

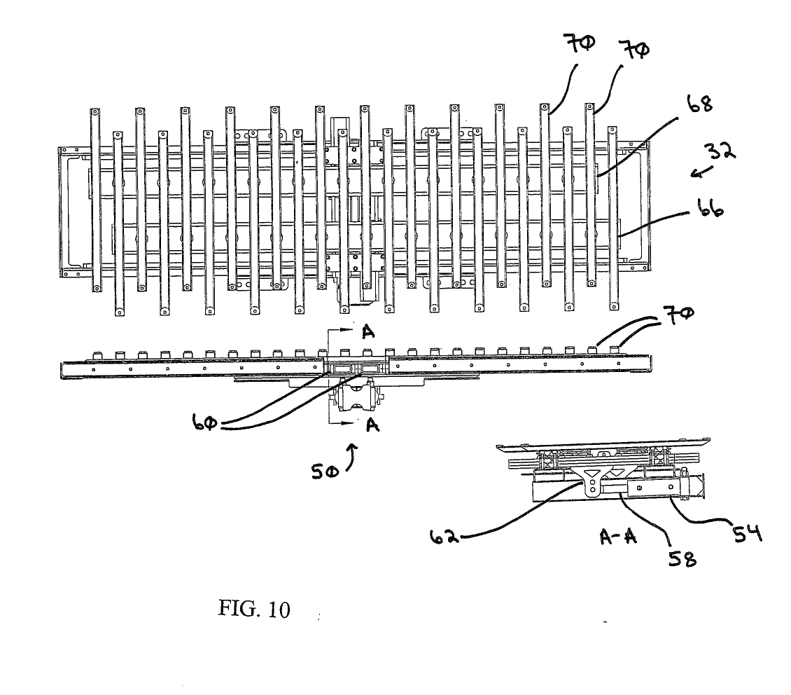

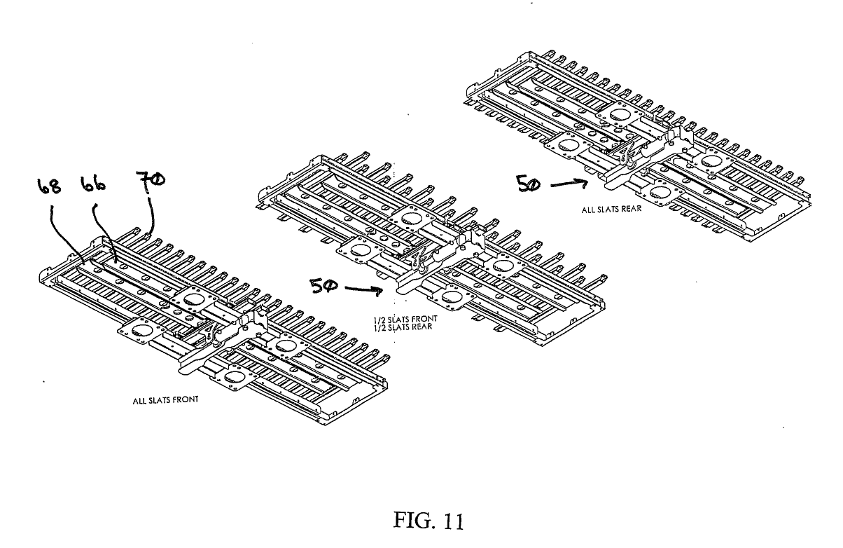

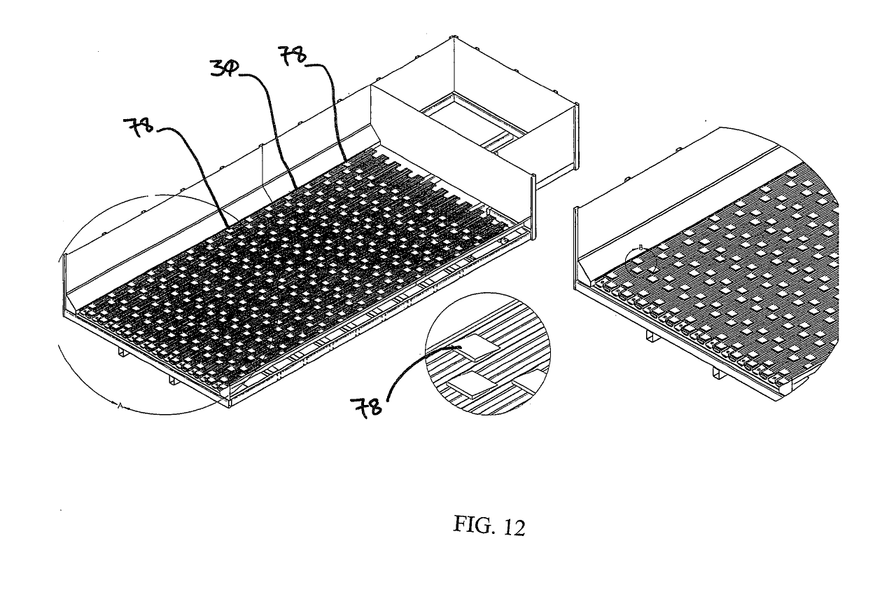

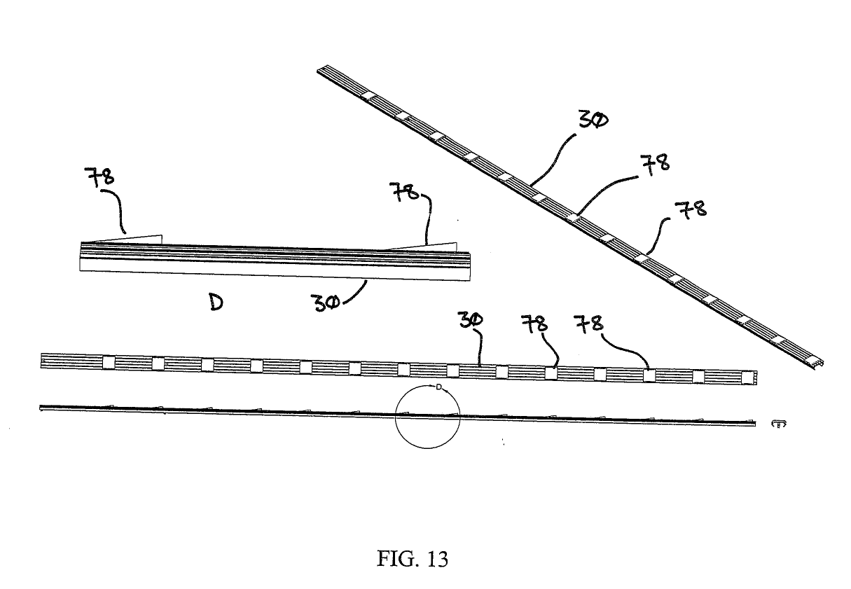

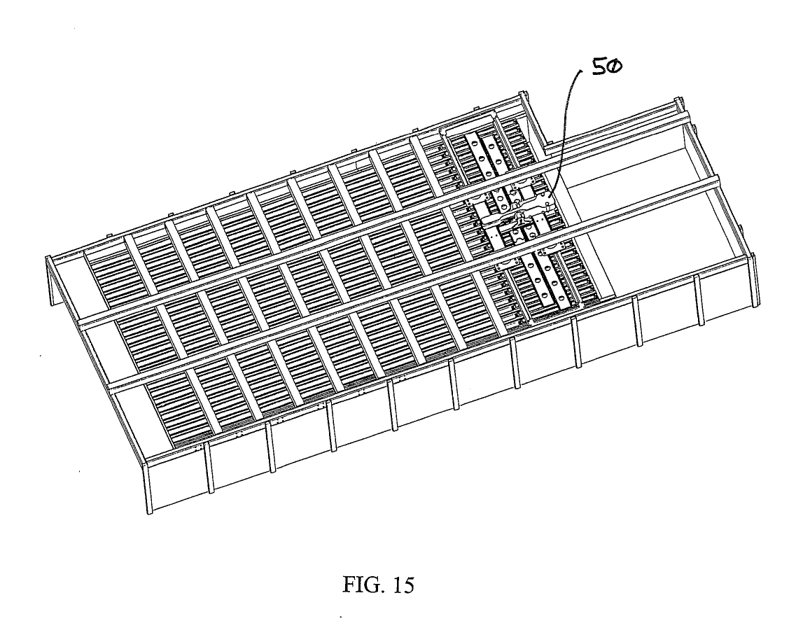

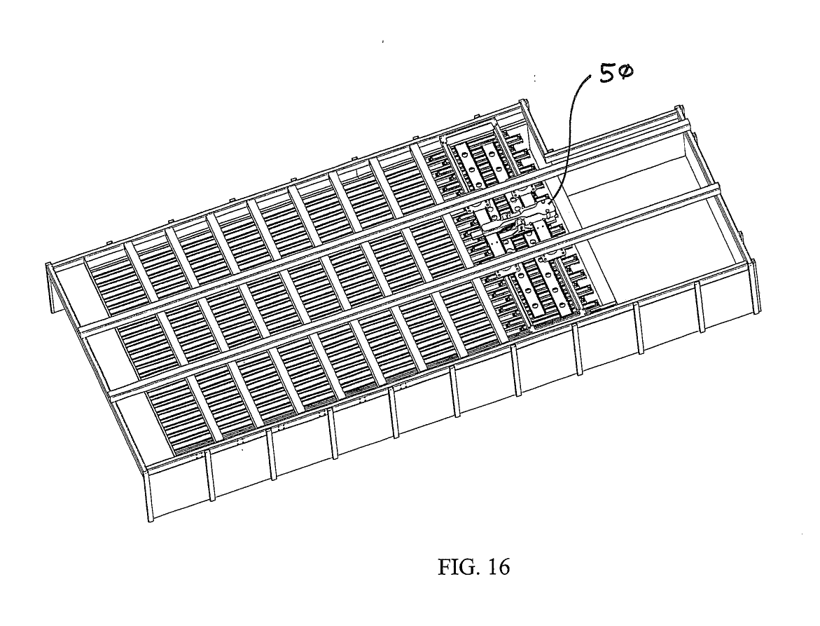

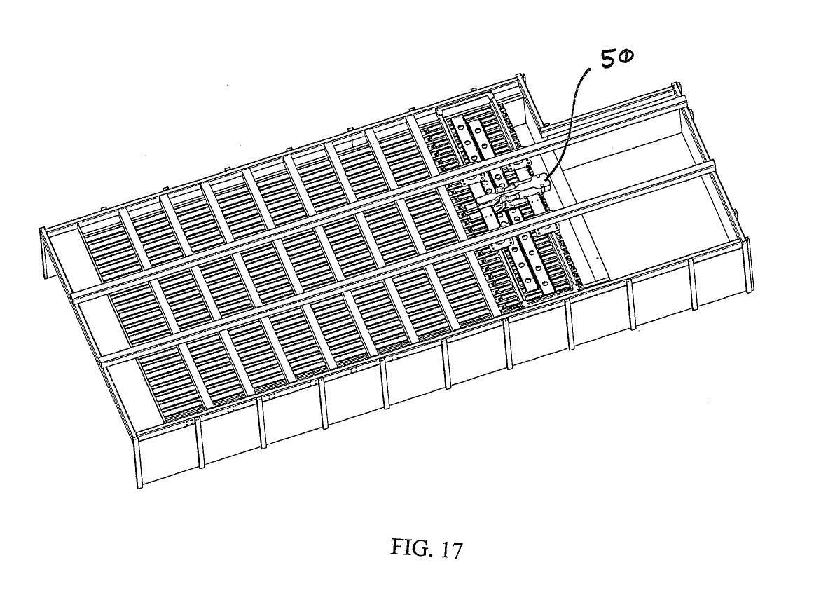

A first reciprocating slat conveyor 10 of the invention is shown in FIGS. 1-17 (particularly FIGS. 1-3) mounted in a cargo receptacle. In the illustrated embodiment, the receptacle is depicted in the form of a trailer 12 having a load support floor 14. However, it is to be understood that the invention is not limited to trailers but could also be practiced in ground-based containment bins. The trailer 12 is shown as a substantially rectangular trailer having a body with a pair of opposed sidewalls 16, a front wall 18, and a rear discharge end 20. The right side wall and top of the trailer 12 are not shown for ease of description of the invention. The trailer floor 14 includes longitudinal support beams 22 running fore and aft and a plurality of lateral supports 24 connected to the longitudinal support beams 22.

The support floor 14 comprises a plurality of elongated load support slats 30 spaced side-by-side across the width of the floor 14. The parallel slats 30 extend along the longitudinal length of the floor 14 between the front end and rear end of the trailer. A drive assembly moves the slats 30 longitudinally, i.e., fore and aft, in the trailer 14, as will be described below. The slats 30 are grouped into a plurality of slat sets. For ease of discussion, the first embodiment of the invention will be described with reference to two slat sets; however, it is to be understood that any number of slat sets could be defined. The slat sets can be moved either all together or selectively by the drive assembly.

In the two-step embodiment in FIGS. 1-17, the slat conveyor 10 includes a frame 32 having a pair of opposed side members 34, a front member 36, and a rear member 38. The side members 30 are connected to the sides of the trailer 14. The frame 32 also includes attachment elements 40, such as attachment plates or pads, to attach the frame 32 to the longitudinal beams 22, such as by bolts or other conventional means. The frame 32 also includes a pair of low friction rails 42 having a top surface 44 extending above the top surface of the front and rear members 36, 38. The frame 32 can be made of any suitable material such as metal. The low friction rails 42 can be, for example, plastic other suitable material. The frame 32 also includes a pair of guides 48, e.g., bearing guides. The guides 48 can be made of or can include low friction material, such as plastic, or the guides 48 can be made of metal and have low friction material inserts.

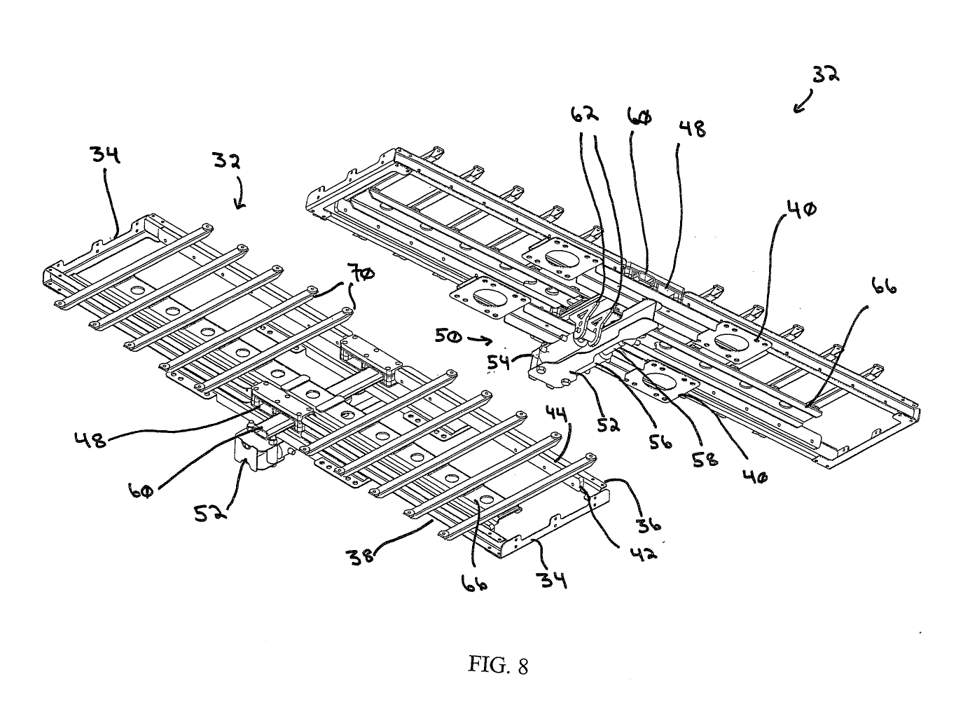

A drive assembly, in the form of a pneumatic or hydraulic piston assembly 50, is connected to the frame 32. In the embodiment shown in FIGS. 1, 7-11, and 15-17, the hydraulic piston assembly 50 includes a support 52 with a first piston 54 and a second piston 56 carried on the support 52. Each piston includes a piston rod 58 connected to a linear member 60 in any conventional manner. In the embodiment shown in FIGS. 8-11, the piston rods 58 are connected to the linear members 60 by a pair of spaced connectors 62 depending from the bottom of the linear member 60 and connected to the piston rod 58. The linear members 60 are slidably engaged with the guides 48 such that, as the piston rod 58 is extended and retracted, the linear members 60 slide fore and aft in the guides 48.

A first cross-beam 66 is attached to one linear member 60 and a second cross-beam 68 is attached to the second linear member 60. A plurality of attachment elements 70 or shoes are connected to one cross-beam 66 and another set of attachment elements or shoes are connected to the other cross-beam 68. The bottom of the attachment elements 70 slide on or are supported by the low friction rails 42. The slats 30 are connected to linear members 60, e.g., to the tops of the linear members 60, in any conventional manner, such as screws, bolts, and the like.

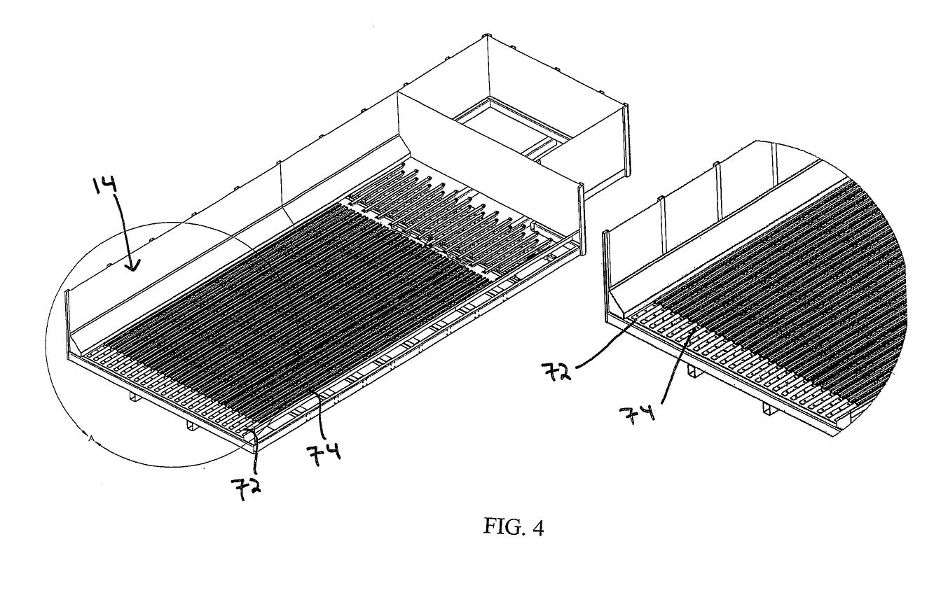

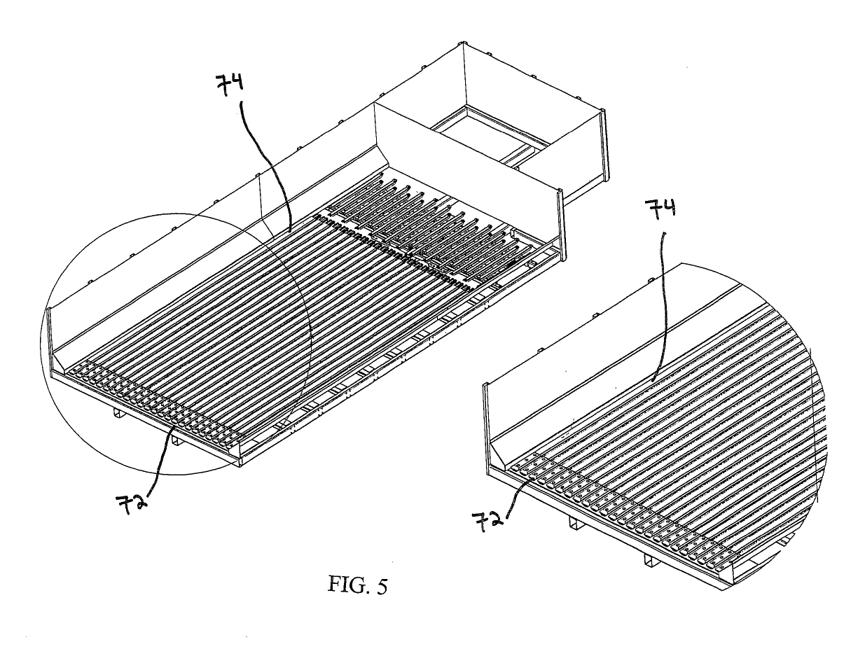

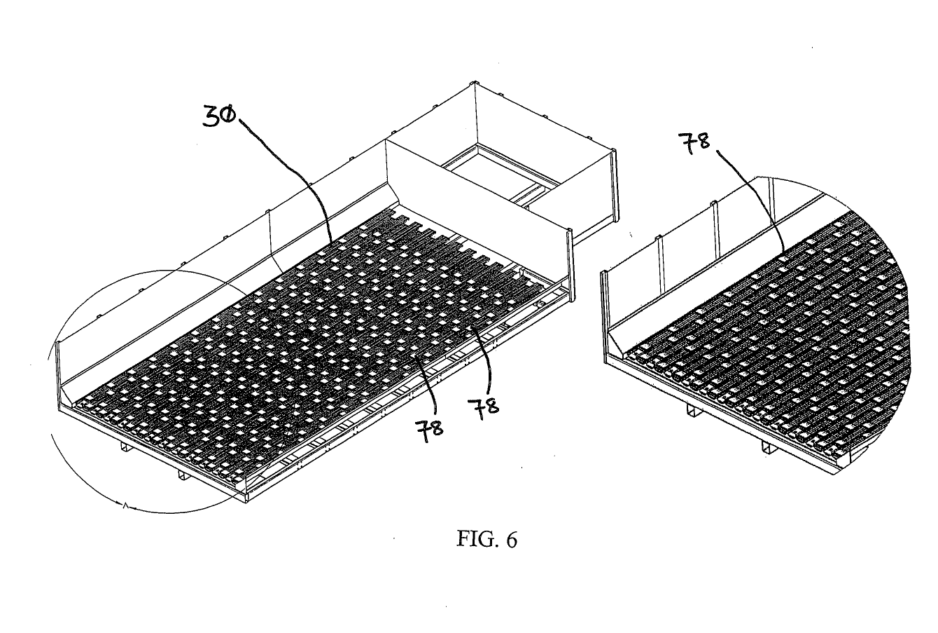

As shown in FIG. 4, a plurality of slat supports 72 extends fore and aft in the trailer 12. As shown in FIG. 5, bearing sleeves 74 are slidably engageable with the support beams 72. As shown in FIG. 6, slats 30 are engaged with the bearing sleeves 74 and are slidable along the bearing sleeves 74 on the slat supports 72.

The slats 30 include a plurality of biasing means to reduce or prevent movement of the cargo when one of the slats is retracted. In this first embodiment, and as shown in FIGS. 6, 12, and 13, the biasing means is in the form of a plurality of spaced substantially wedge-shaped elements 78 attached to or formed on the top of the slat 30 and extending above the slat surface. The pointed end of the wedge 78 faces the front of the trailer 12 and the blunt end of the wedge 78 faces the rear (discharge end) of the trailer.

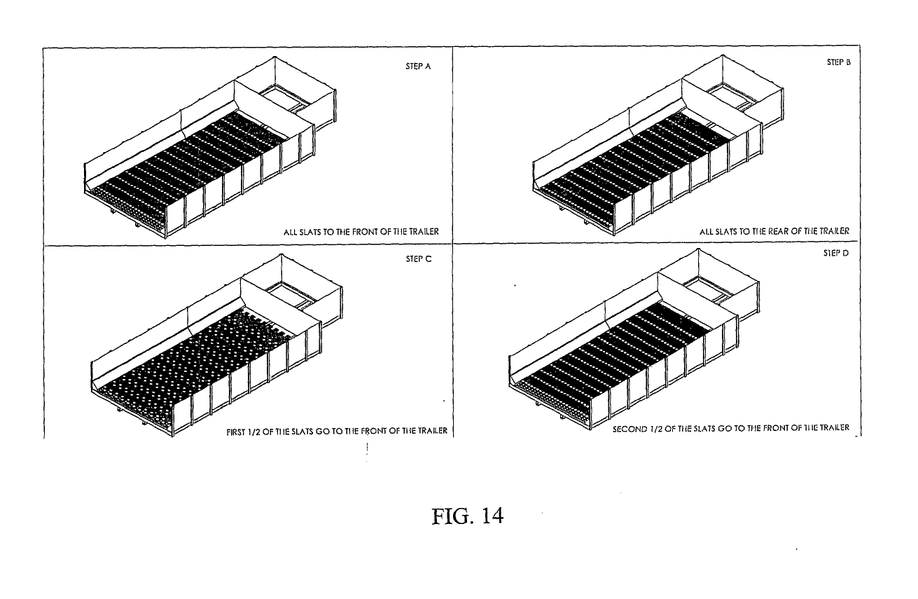

Operation of the slat conveyor 10 will now be described with reference to FIG. 14. Assuming that a cargo (not shown) is carried in the trailer 12, as shown in Step A, all of the slats 30 are in the forward most position. That is, the piston rods 58 of the pistons 54, 56 are retracted such that the cross-beams 66, 68 are in their forward most position (see FIG. 4). To offload the cargo, both of the piston rods 58 of the hydraulic pistons 54, 56 are extended to move all of the slats 30 toward the rear of the trailer 12. The movement of the slats 30 rearwardly moves the cargo towards the rear of the trailer 12, as shown in Step B. Next, one set of slats 30 is returned to the starting position (forward position) by retracting the piston rod 58 on one of the hydraulic pistons 54, as shown in Step C. The wedges 78 help prevent the cargo from also moving forward in the trailer 12. As will be appreciated, as the set of slats 30 is moved forwardly, the cargo can slide over and around the tapered end of the wedge 78 without causing undue amounts of the cargo to move forwardly. Also, the wedges 78 on the set of slats 30, not being moved, help prevent the cargo from moving forwardly since the blunt ends of the wedges 78 on the slats not being moved face to the rear and thus hinder cargo moving forwardly. After retraction of the first set of slats 30, the second set of slats 30 is also moved to the starting position by retracting the piston rod 58 on the other hydraulic piston 56, as shown in Step D. After both sets of slats 30 are in the forward most position, all of the slats 30 are then again moved rearwardly and Steps B-D are repeated until the cargo is offloaded. To on-load cargo, the cycle would simply be reversed.

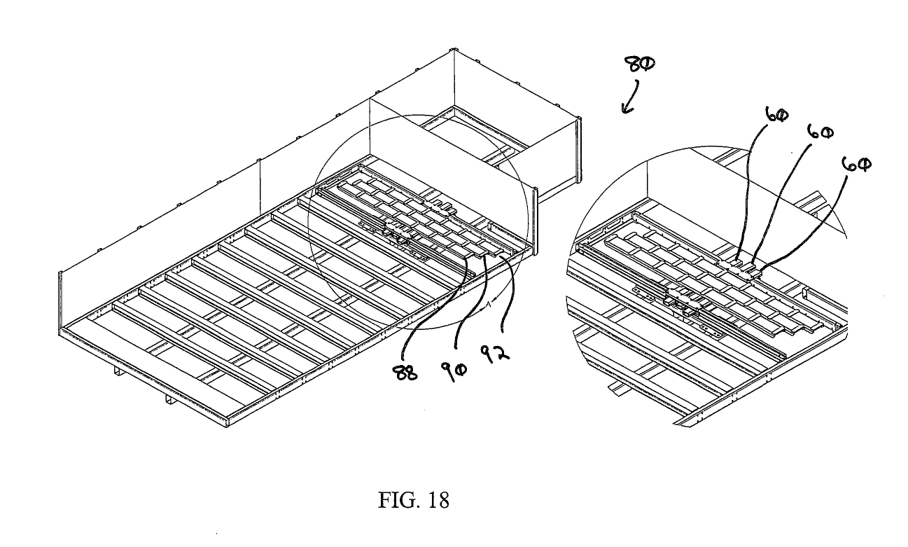

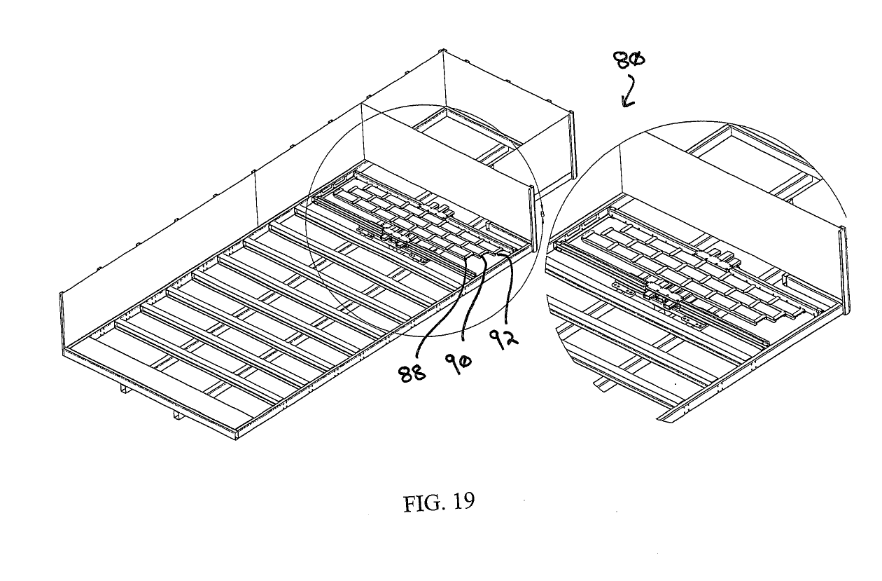

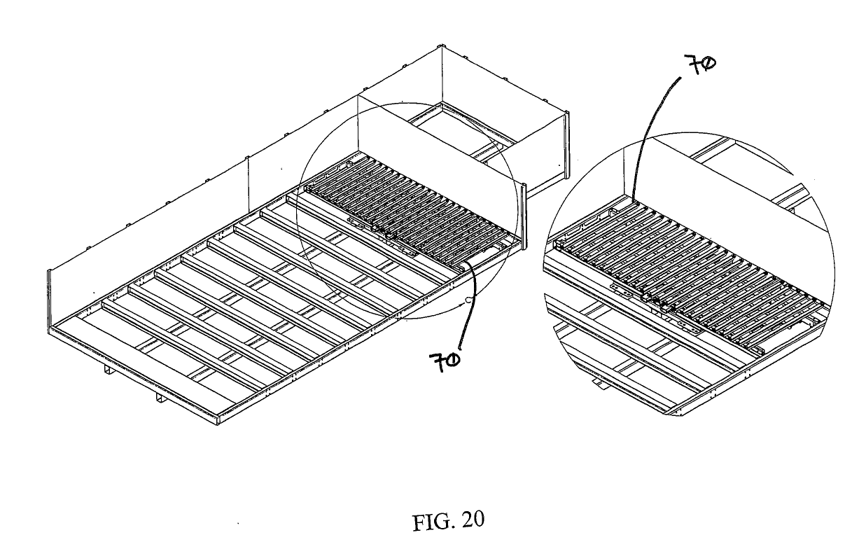

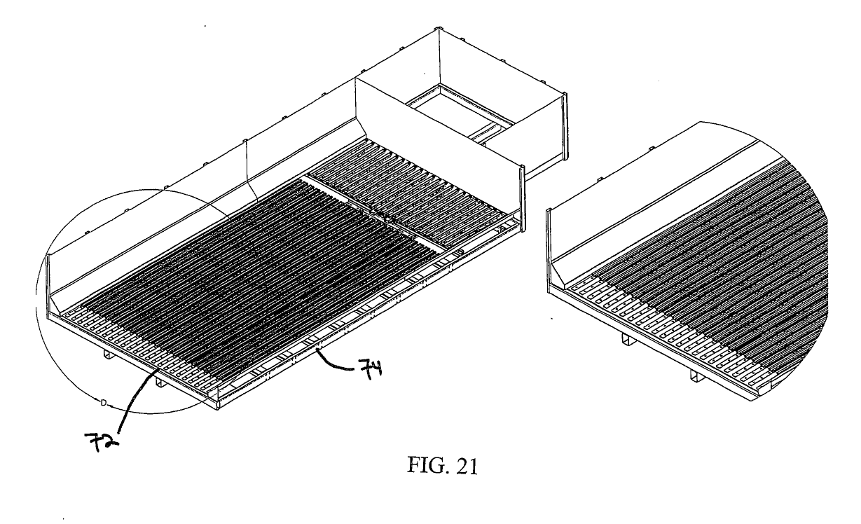

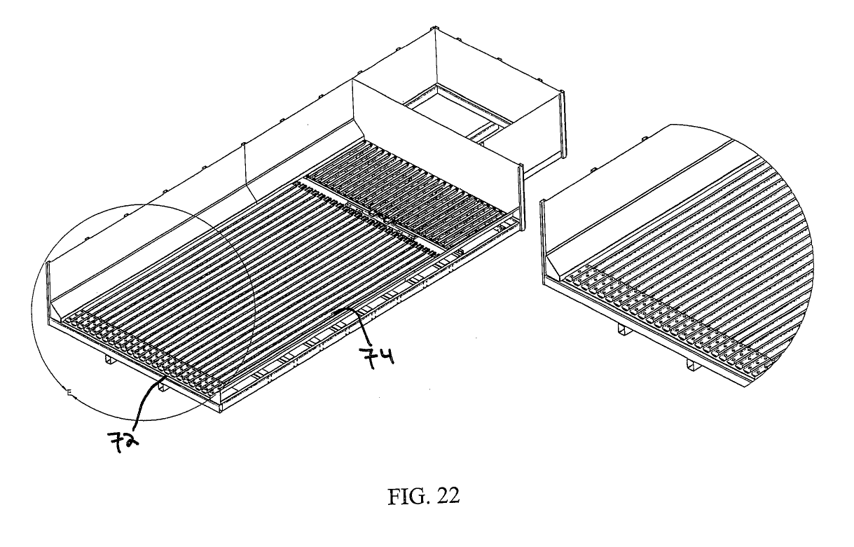

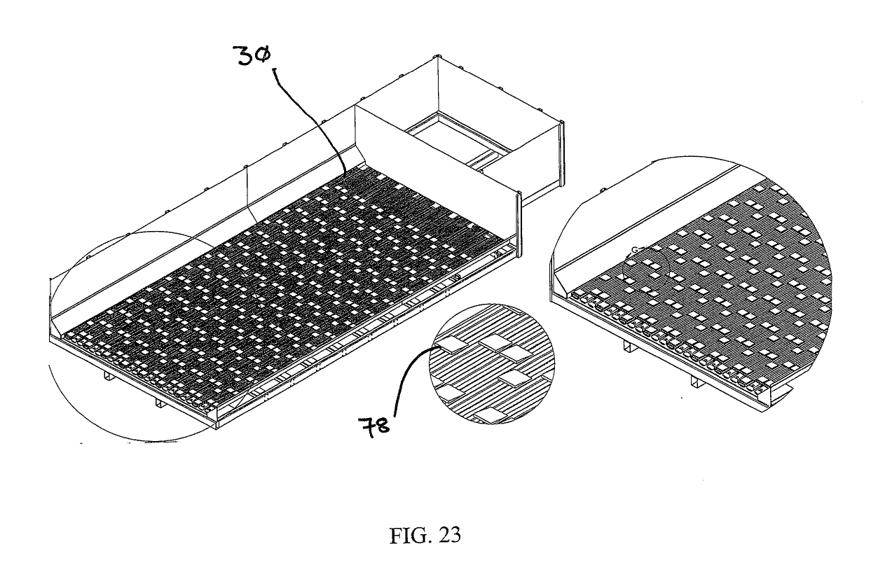

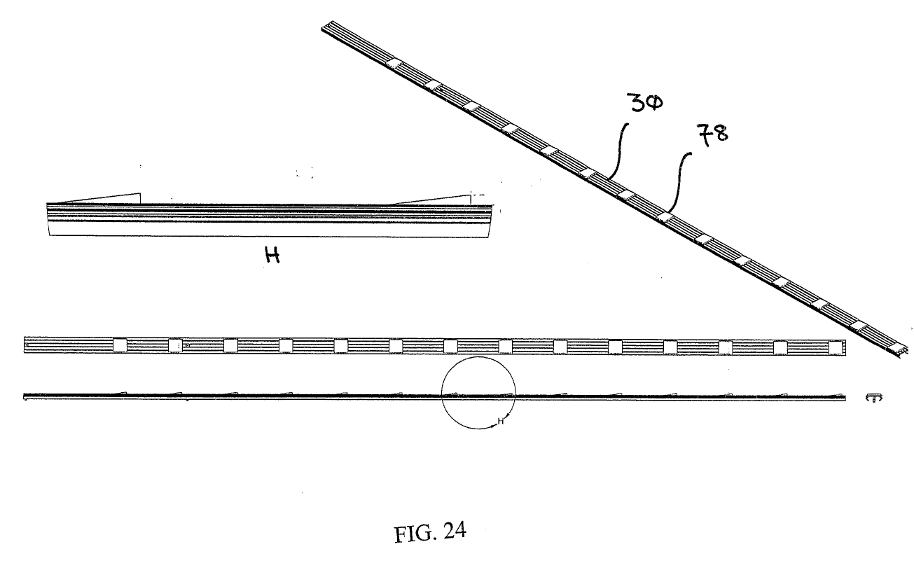

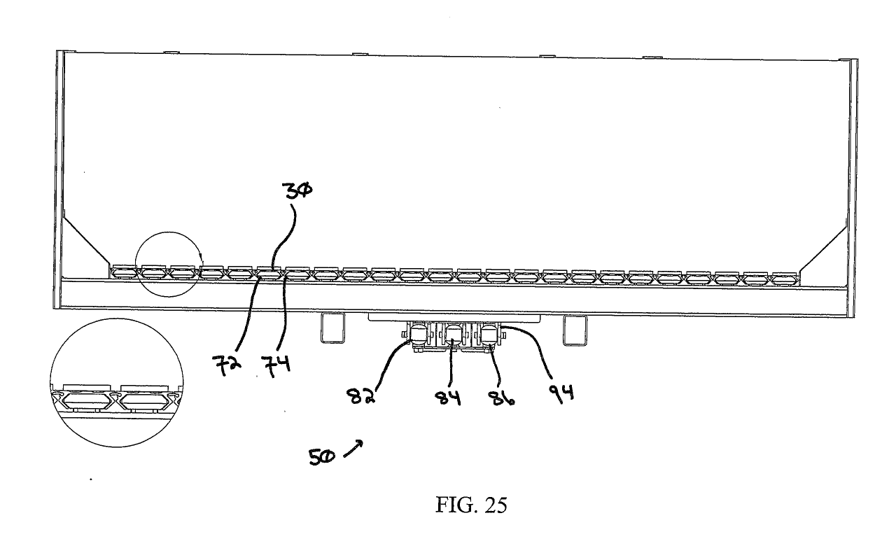

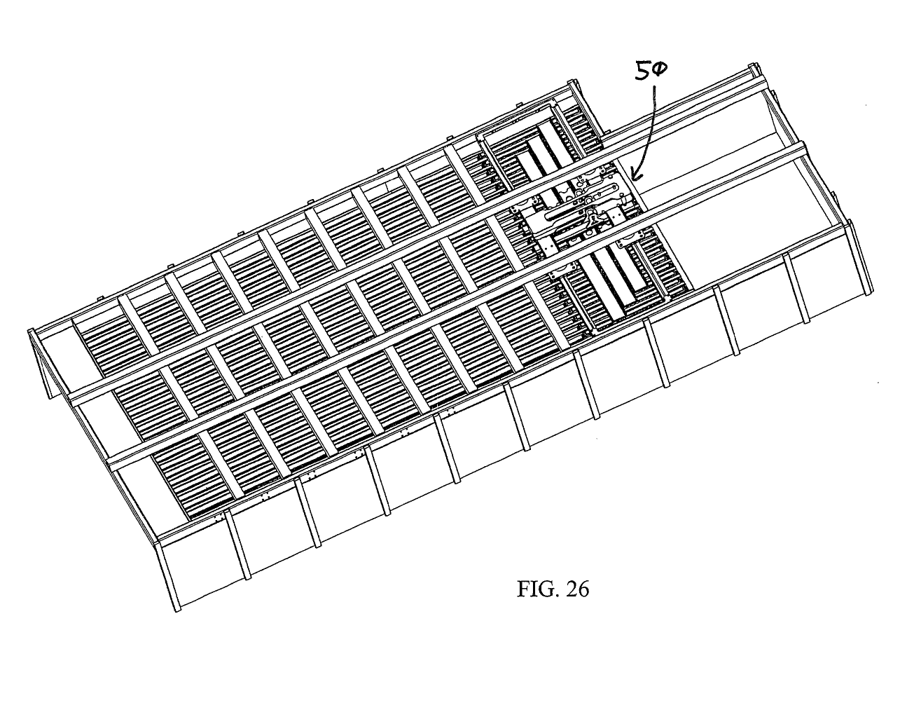

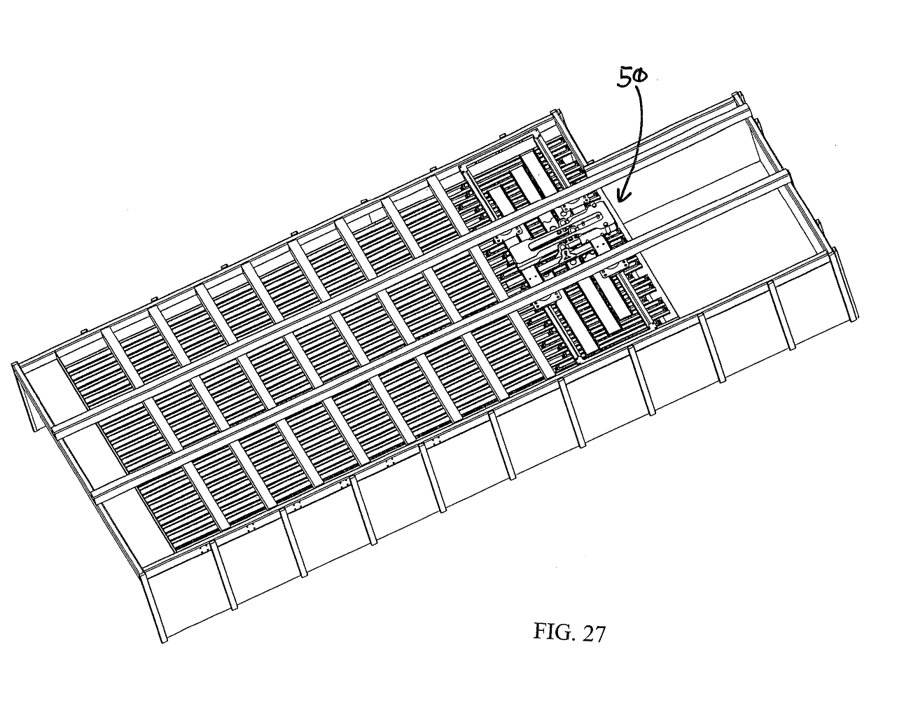

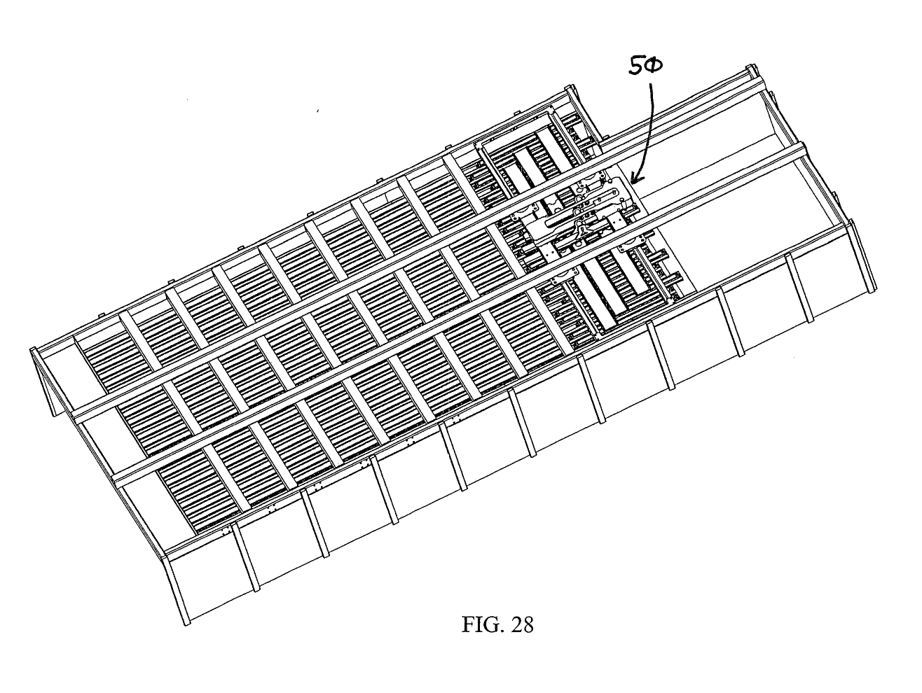

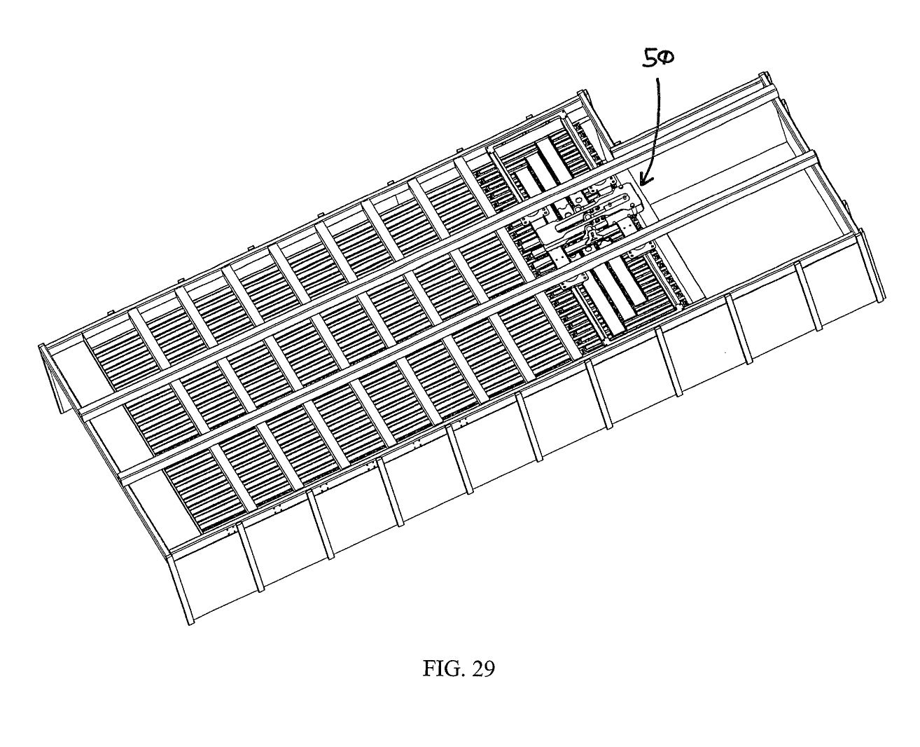

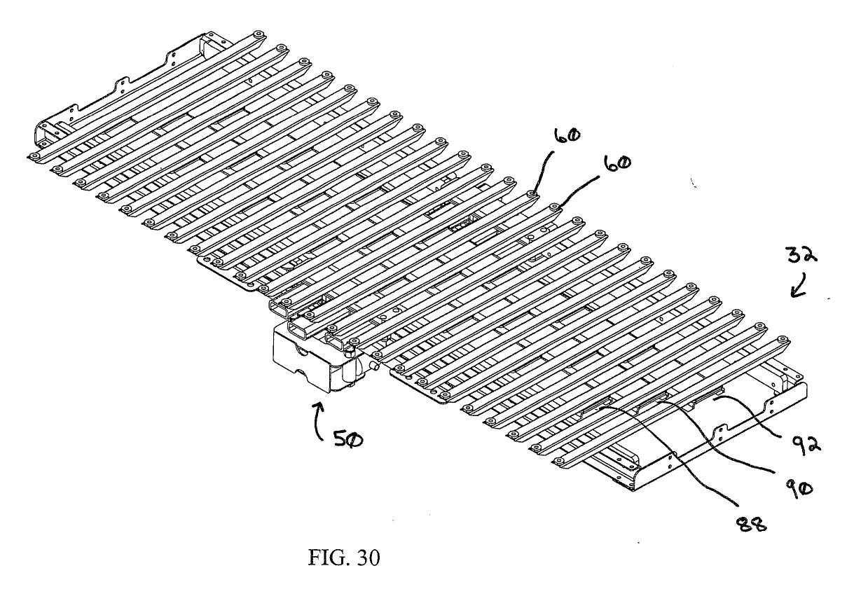

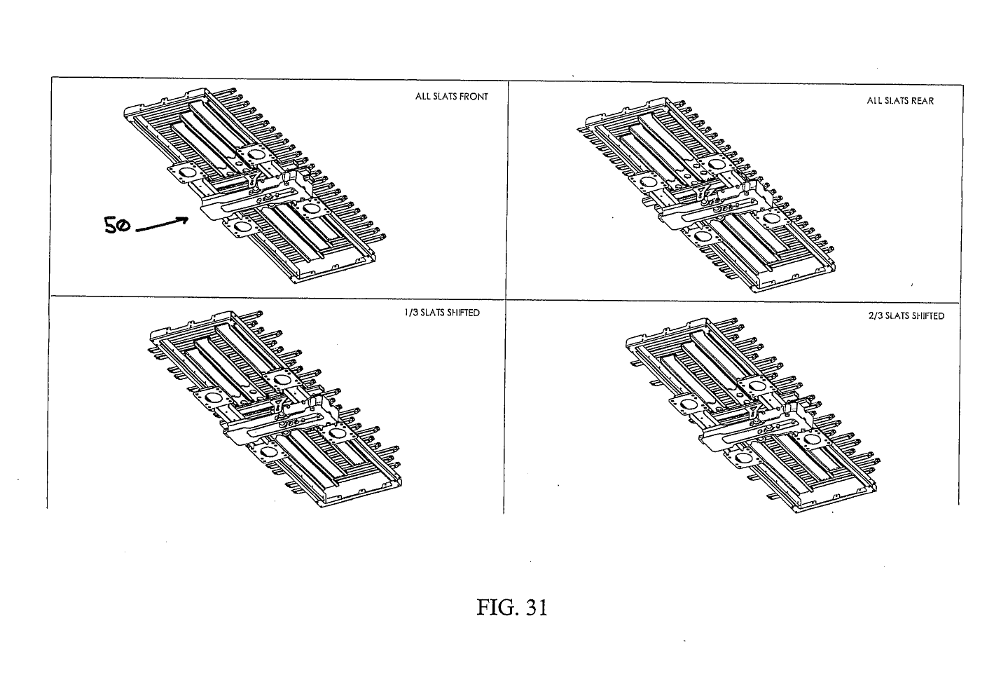

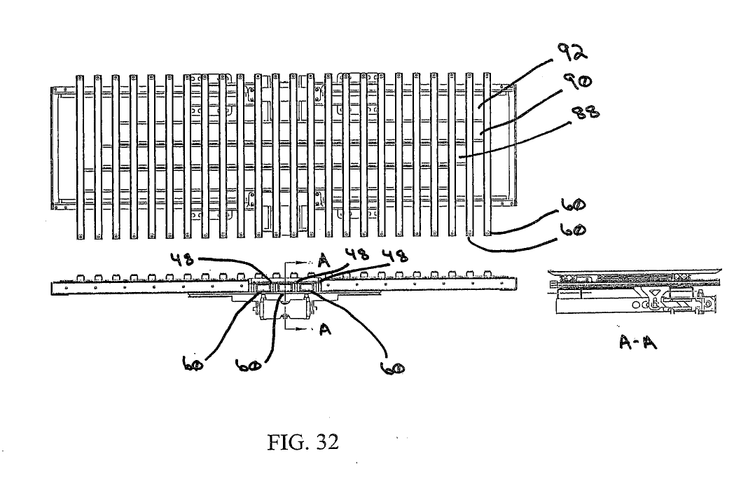

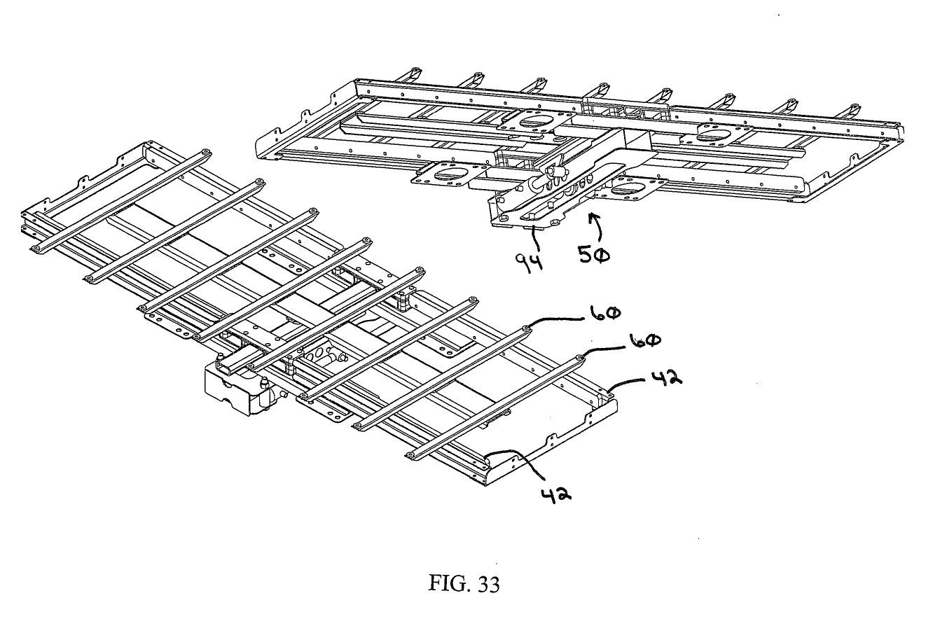

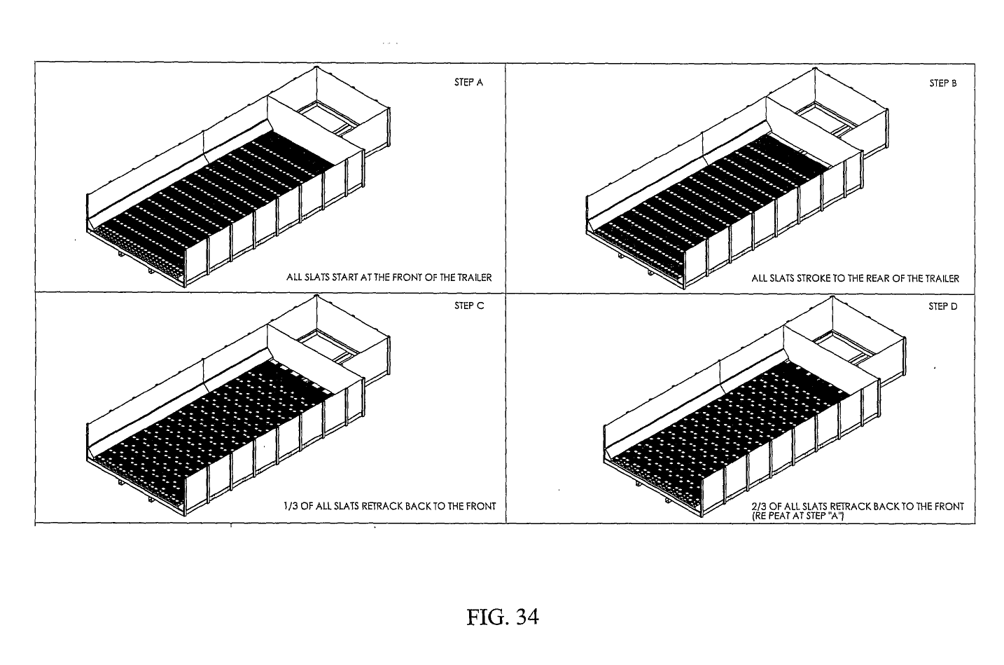

Another conveyor embodiment is shown in FIGS. 18-34. The slat conveyor 80 includes three pistons 82, 84, 86 and three sets of slats 30 rather than two, as described above. Therefore, three guides 88 are formed in the frame 32, with one linear member 60 slidable in each guide and connected to one of the hydraulic pistons 82, 84 86. Three cross-beams 88, 90, 92 are provided, with one cross-beam attached to each of the linear members 60. As shown in FIGS. 25-29, the hydraulic piston assembly 50 includes the three pistons 82, 84, 86 connected to a piston support 94 on the underside of the frame 32. A set of attachment elements (shoes) 70 is connected to each of the cross-beams 90, 92, 94 to form three sets of the moveable slats 30. Operation of this embodiment is similar to that described above; however, as shown in FIG. 34, only one-third of the slats 30 are retracted at a time to prevent cargo from moving towards the front of the trailer.

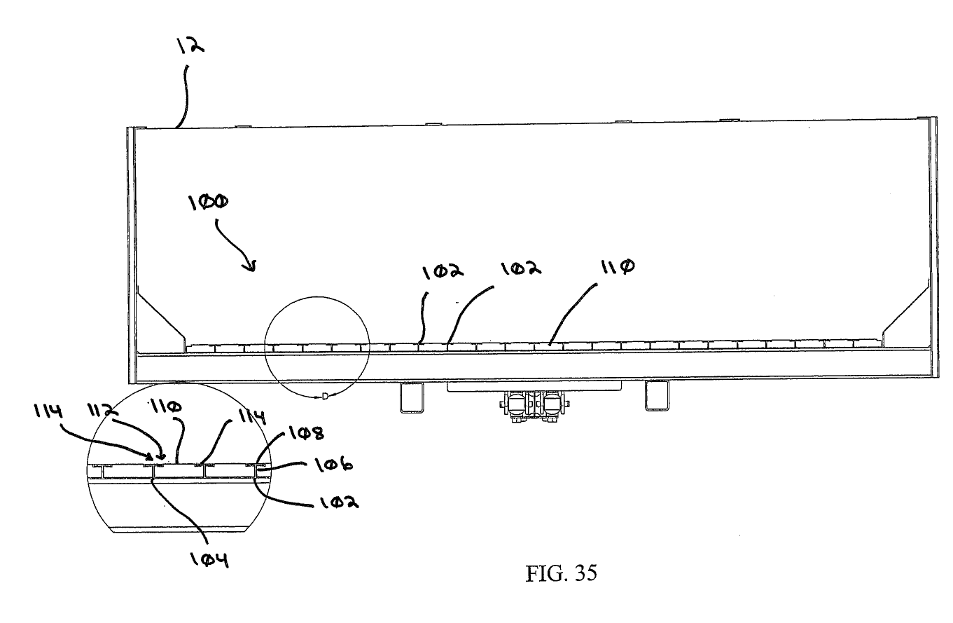

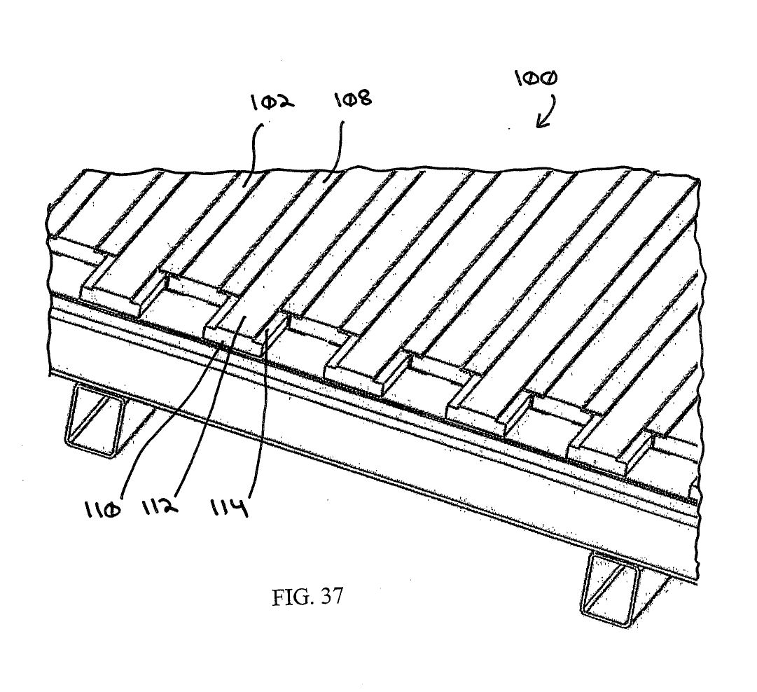

Another two-step conveyor 100 is shown in FIGS. 35-38. In this embodiment, a plurality of substantially I-shaped rails or guides 102 are fastened to the floor of the trailer 12. The guides 102 have a base 104, a web 106, and a top 108 formed by flanges extending from the web 106 with a top surface substantially level with the top surface of the slats, as will be described in further detail. As will be understood particularly from FIG. 35, channels are formed between the adjacent guides 102 in which the slats 110 slide. As shown in FIGS. 35 and 37, the slats 110 have a stepped profile with a flat top 112 and a step 114 formed on each side of the slat 110. The slats 110 are slidable in the channels formed between the adjacent guides 102 with the top of the step 114 sliding along or adjacent the bottom of the guide top 108. The forward end of the slats 110 can be connected to a drive assembly in any conventional manner. For example, the slats 110 can be connected to a drive assembly similar to that shown for the embodiment shown in FIGS. 1-17.

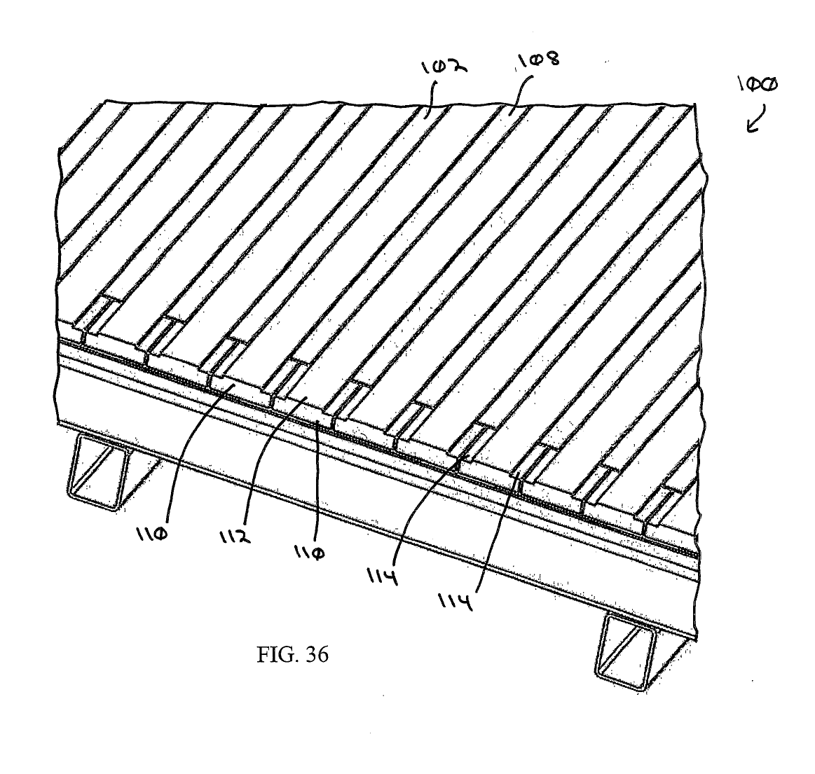

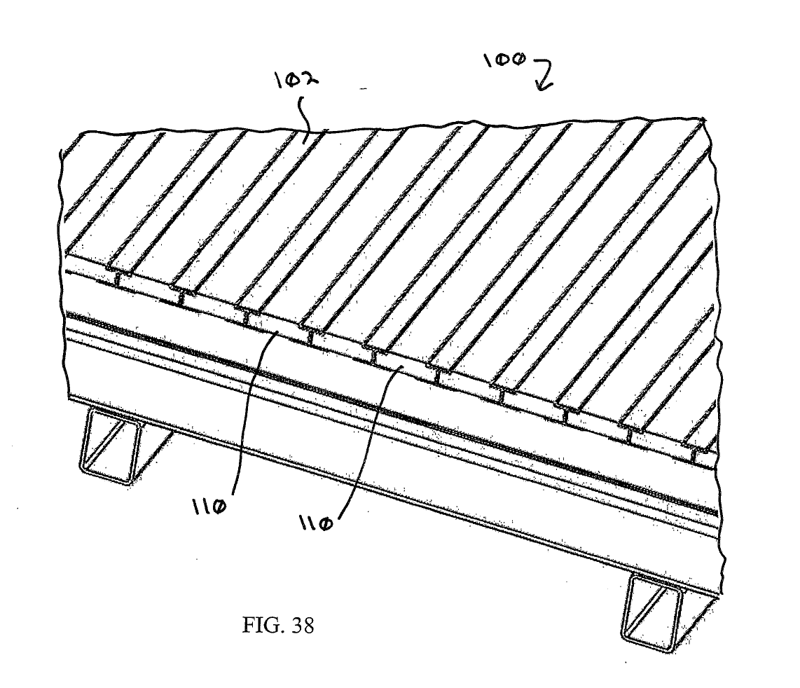

Operation of the conveyor 100 will now be described with particular reference to FIGS. 36-38. As shown in FIG. 36, all of the slats 110 are in their rearward most position. When a piston of the drive assembly is actuated, one of the sets of slats 110 is moved forwardly in the trailer 12 while the other set of slats 110 remains stationary. As will be appreciated from FIG. 37, the combined surface area of the stationary (non-moving) slats 110 and the top surface 108 of the guides 102 is greater than the surface area of the top of the slats 110 being moved. Therefore, the cargo will tend to remain in place and not be pulled forwardly in the trailer. As shown in FIG. 38, the second set of slats 110 is then moved forwardly such that both sets of slats 110 (i.e., all of the slats) are in their forward most position. The cycle can then be repeated as required.

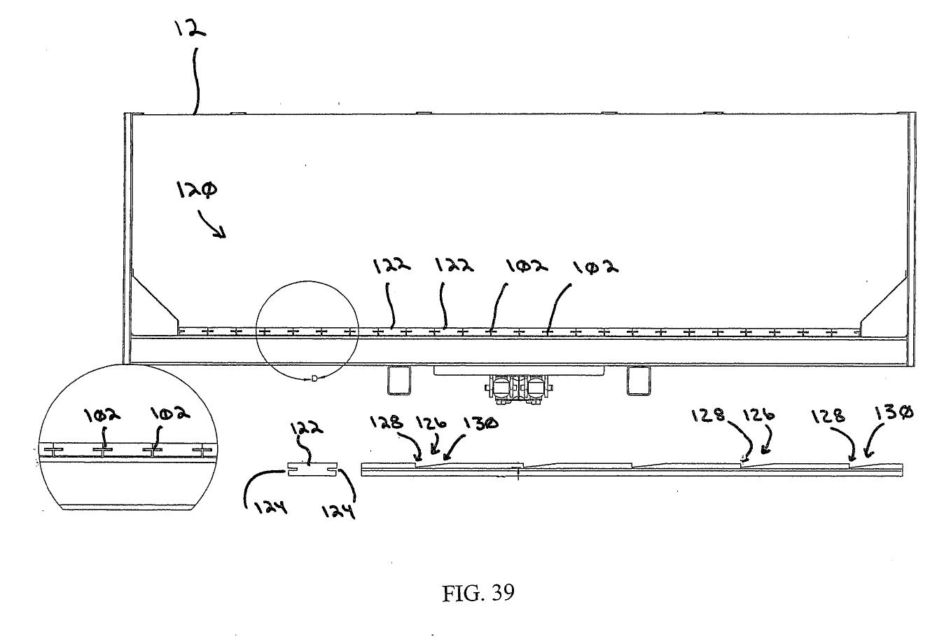

Another slat conveyor 120 is shown in FIG. 39. This conveyor 120 is similar to the conveyor 100 described above. However, in this embodiment, the slats 122 include a groove 124 formed on each side of the slat 122. The grooves 124 engage the outwardly extending flanges of the guides 102 and are slidable along the guides 102. In this embodiment, the biasing means is formed by wedge-shaped notches 126 cut into or formed into the top of the slats 122. The blunt end 128 of the notch 126 faces the rear of the trailer 12.

As will be appreciated from the above description, operation of this conveyor 120 is similar to that described above for the conveyor 100. However, in this embodiment, when one set of slats 122 is moved forwardly, the cargo slides over the tapered portion 130 of the notch 126. Since the blunt ends 128 of the slats 122 not being moved face the rear of the trailer 12, these blunt ends 128 help prevent or reduce movement of the cargo forwardly when one of the slat sets is being moved.

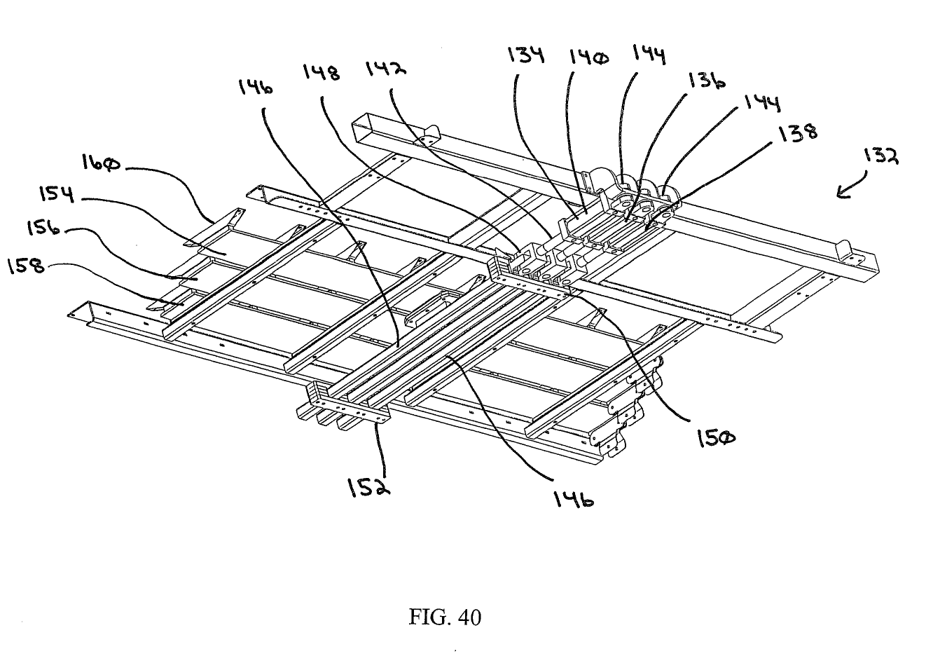

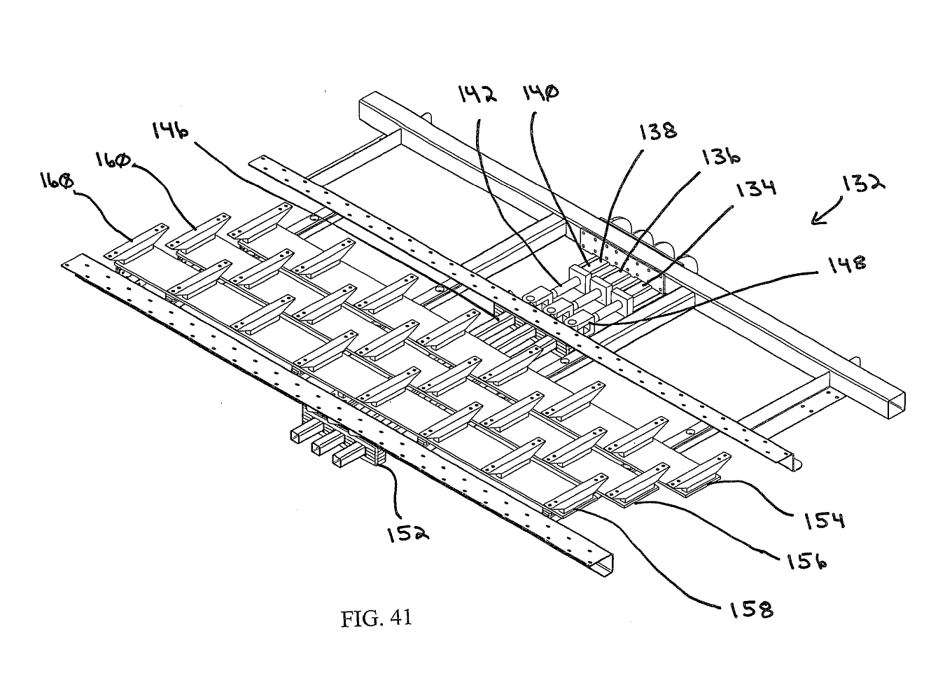

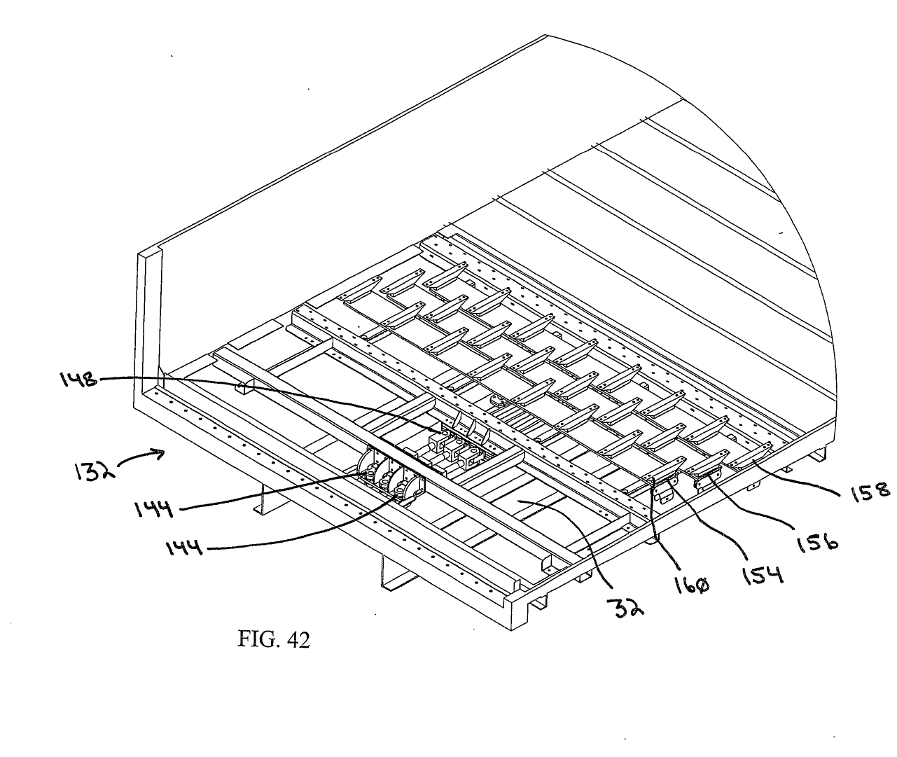

FIGS. 40-43 illustrate a drive assembly 132 for a three-step conveyor. The drive assembly 132 is in the form of a pneumatic or hydraulic piston assembly and is connected to the frame 32 of the vehicle, such as by connection to one of the vehicle cross-beams. In the illustrated embodiment, the drive assembly 132 includes a first piston 134, a second piston 136, and a third piston 138. Each piston 134-138 includes a cylinder 140 having an associated piston rod 142. The cylinders 140 are connected to the vehicle frame, such as being connected to a lateral support of the vehicle by a non-alignment critical connector, such as a conventional swivel socket or similar device, to permit relative movement between the cylinder and the frame. In the illustrated embodiment, the cylinders 140 are connected or attached to the frame by a U-shaped connector 144. The connector 144 can be positioned vertically as shown in FIG. 40 to receive a connecting element, such as a bolt, pin, or similar element to attach the cylinder 140 to the vehicle frame. Each piston rod 142 is connected to a linear member 146 by another non-alignment critical connector, such as a U-shaped connector 148. The non-alignment connector permits some degree of movement or misalignment between the piston rods and the linear members to help offset any damage that could be caused by twisting or torque forces generated during operation of the conveyor. The connector 148 can be positioned horizontally as shown in FIG. 40 or can be positioned vertically as in the U-shaped connector 144 connected to the cylinder 140. The linear members 146 are slidably engaged with bearing guides, such as a front guide 150 and a rear guide 152. The guides include a low friction material, as described above. Thus, as the piston rods 142 are extended and retracted, the linear members 146 slide fore and aft in the guides 150 and 152. The linear members 146 are connected to cross-beams 154-158. A plurality of attachment elements 160 are connected to the cross-beams 154-158. As described above, the slats of the conveyor are connected to the attachment elements 160, such as by bolts or screws, such that movement of the cross-beams moves the slats.

Operation of the slat conveyor 132 is similar to the conveyors described above. Conveyor 132 uses a three-step process rather than a two-step process.

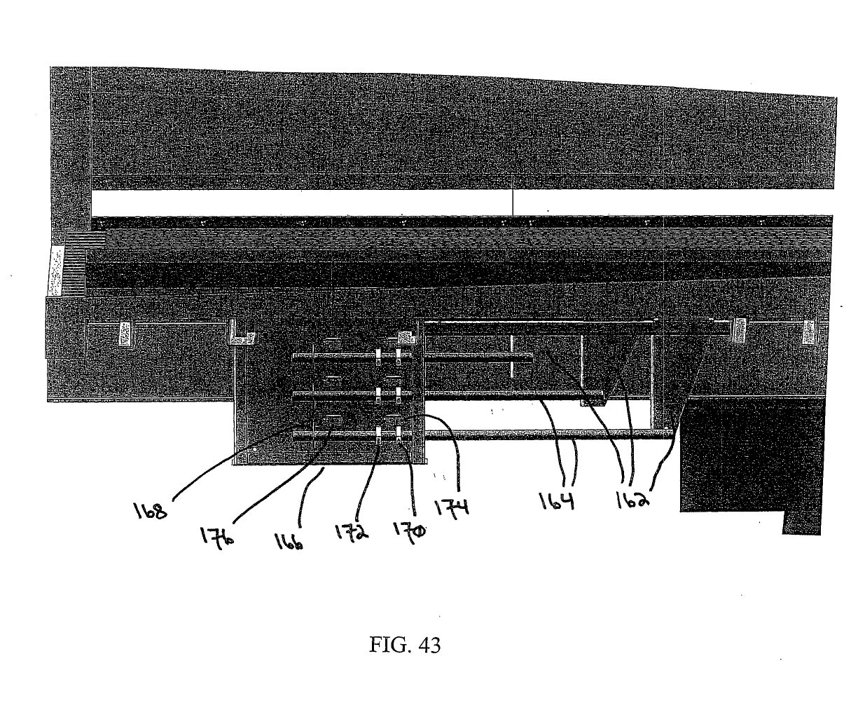

Another aspect of the invention is shown in FIG. 43. Each cross-beam 154-158 includes a depending element 162 attached to an associated cross-beam. A position rod 164 is connected to each depending element 162 and extends into a control box 166. A rear portion of the position rod 164 is slidable in a guide 168. Each position rod 164 includes a first metallic member 170 spaced from a second metallic member 172. In the illustrated embodiment, the first and second metallic members 170, 172 are shown as attached to the outer surface of the position rods 164. However, this is simply one illustrated embodiment and the metallic members 170, 172 could be interior to the position rods 164 as well. The control box 166 also includes spaced proximity sensors, such as a forward sensor 174 and a rear sensor 176. As will be appreciated by one skilled in the art in the embodiment shown in FIG. 43, all of the cross-beams 154-158 are in the forward position. In this position, the first metallic members 170 are adjacent the forward sensors 174. As the cross-beams 154-158 are moved towards the rear, the position rods 164 slide rearwardly and the second metallic member 172 approaches the rear sensor 176. The sensors 174 and 176 can control or signal a control unit to inform the unit when the cross-beams are in their forward most position (the first metallic members 170 are adjacent the forward sensors 174) or a rear most position (the second metallic members 172 are adjacent the rear sensors 176) to cycle the cross-beams 154-158 by directing hydraulic fluid towards or away from the cylinders.

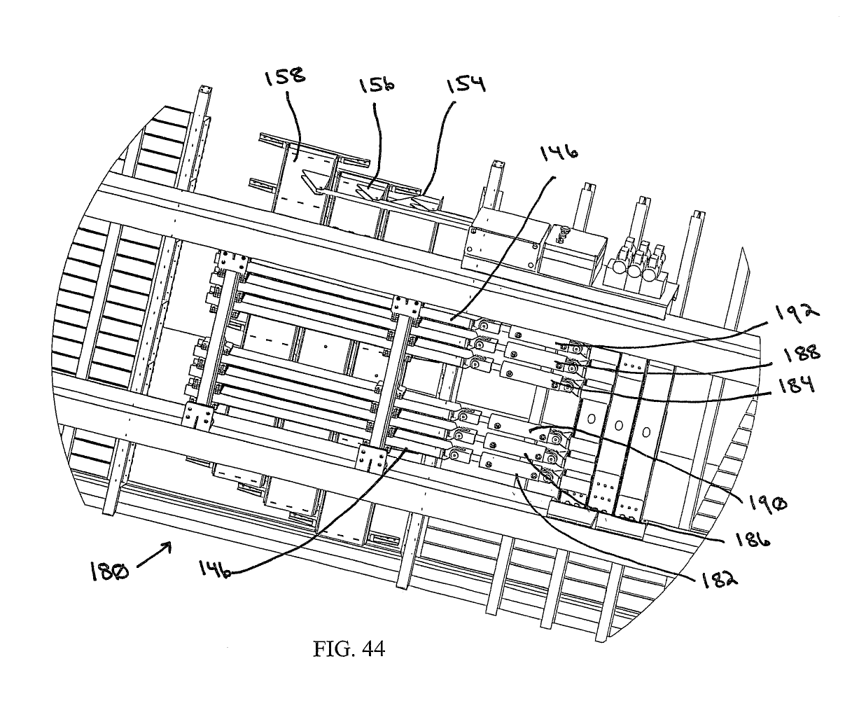

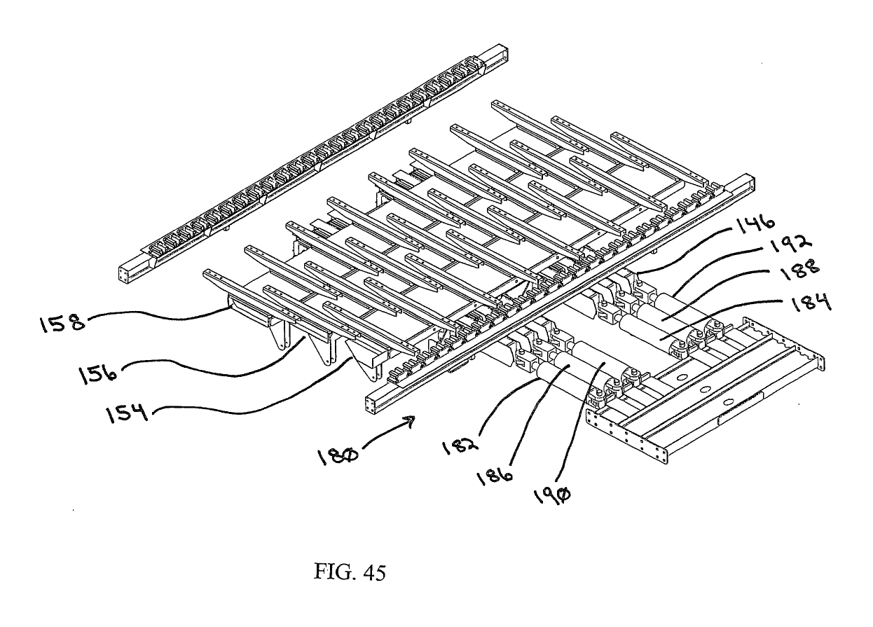

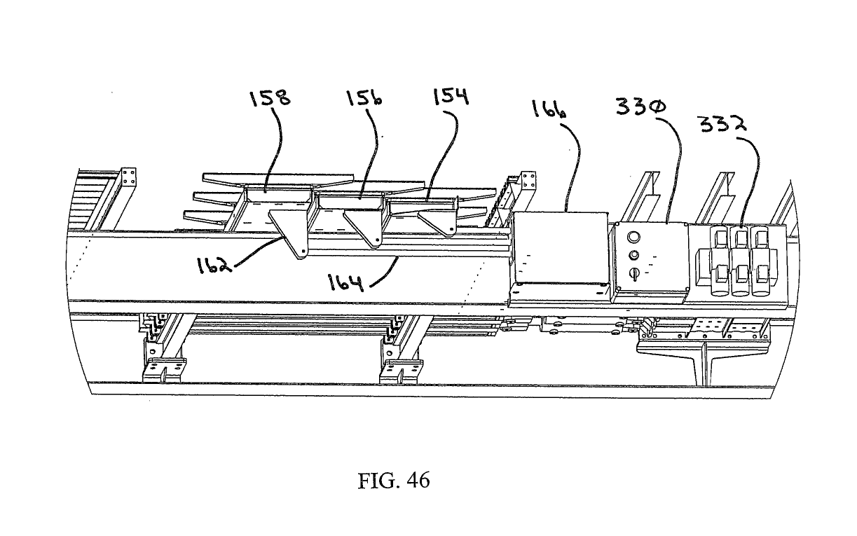

Another conveyor drive assembly 180 is shown in FIGS. 44-46. This drive assembly 180 is similar to the drive assembly 132, however, in this embodiment, each cross-beam is associated with two pistons, rather than one piston. For example, one set of pistons 182 and 184 can be connected to linear members 146 connected to one of the cross-beams, for example, the first cross-beam 154. Pistons 186 and 188 can be connected to linear members 146 attached to another of the cross-beams, such as the second cross-beam 156. Pistons 190 and 192 can be connected to linear members 146 attached to the other of the cross-beams, such as the third cross-beam 158. As shown particularly in FIG. 46, the conveyor of the invention can also include a controller 330. The controller 330 can include a conventional PLC having or in operational connection with a timer. A hydraulic valve assembly 332 having hydraulic valves is in operational connection with the cylinders of the drive assembly to direct hydraulic fluid to the cylinders to extend and/or retract the cylinder rods. Since the control box 166, controller 330, and valve assembly 332 are located on the side of the conveyor, such as on the side of the trailer frame, these components are much easier to service and maintain than prior systems. Operation of the drive assembly 180 is similar to that of the drive assembly 132 except that to actuate the cross-beams, two of the pistons are actuated rather than one piston.

The conveyors of the invention can have several redundant levels of control. For example, in one mode, the stroke of the pistons of the hydraulic drive assembly can be controlled by the several sets of proximity sensors 174 and 176 sensing either the completion of the forward stroke or the rearward stroke, respectively, of the cylinders by sensing the movement of the multiple position rods 164.

In another mode, rather than having one position rod 164 connected to each cross-beam, only one cross-beam would be connected to a position rod 164. Thus in FIG. 43, only one position rod 164 would be present extending into the control box 166 and only one set of sensors 174, 176 would be present. In this mode of operation, the sensors 174, 176 are connected to the PLC and the time it takes the position rod 164 to move from one sensor 174 to the other sensor 176 is measured. The PLC then uses that measured time to control the flow of hydraulic fluid from the valve assembly 332 to the cylinders to essentially transfer that measured stroke time to the other cylinders. Since only one position rod and one set of sensors is needed into this mode, the mechanical considerations are greatly reduced.

In another embodiment of the invention, the hydraulic pistons can be controlled by a timer connected to the PLC that causes the pistons to extend for a predetermined amount of time and then retract for a predetermined amount of time. That is, the timer controls the time hydraulic fluid is supplied to the cylinders. Each piston can be controlled individually by such a timer so that rather than a complex sensing arrangement to sense the piston stroke, each piston can simply be controlled to extend and/or retract for a predetermined amount of time. This greatly simplifies the control aspects of the drive assembly. The timer can be adjustable, such as via a potentiometer, so that the time it takes the pistons to extend and/or retract can be adjusted to adjust the time to onload or offload cargo.

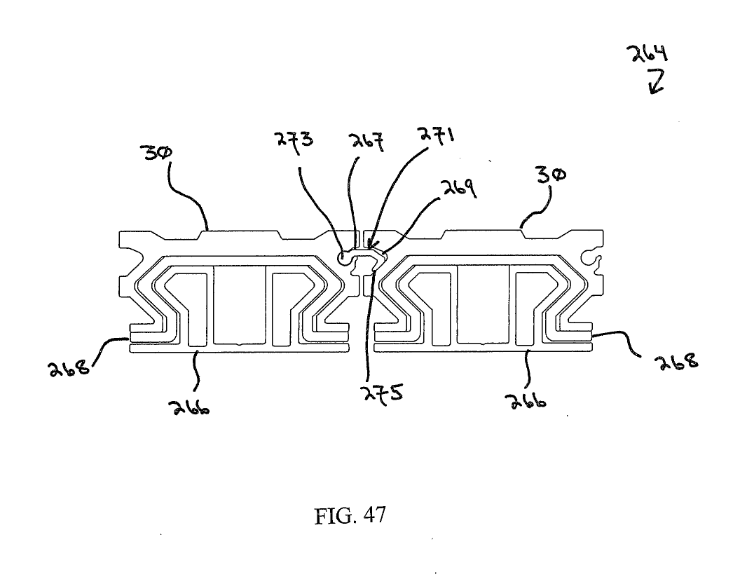

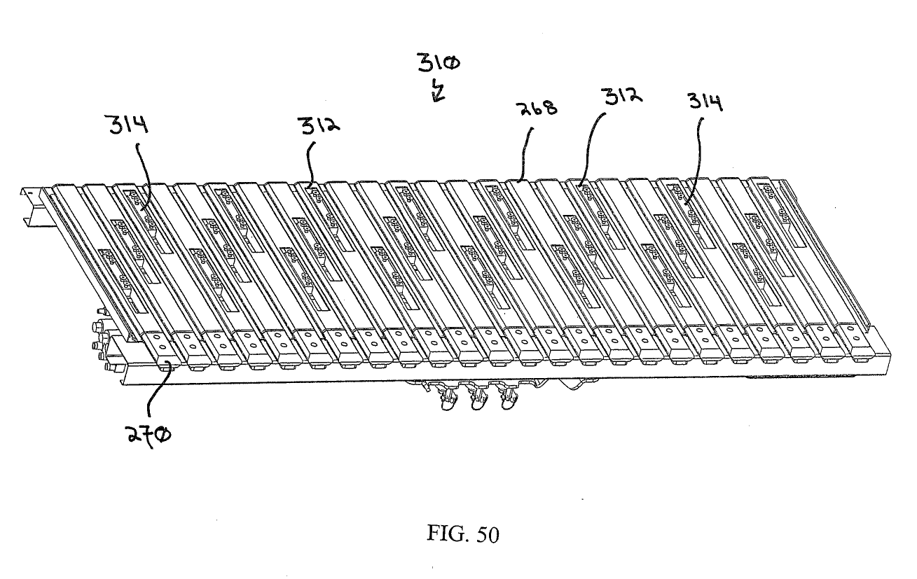

FIG. 47 shows a cross-sectional view of a deck assembly 264 of the invention. The deck assembly 264 includes support beams 266 having an exterior profile. In one aspect of the invention, bearing sleeves 268 of a low friction material, such as a plastic material, are connected to the support beams 266 by slipping one end (forward end) of the bearing sleeve 268 onto the end of the support beam 266 and then pushing the bearing sleeve 268 forward so that the inner profile of the bearing sleeve 268 mates with at least a portion of the outer profile of the support beam 266. The bearing sleeves 268 have an inner profile that is complementary to at least a portion of the outer profile of the support beams 266 to keep the bearing sleeves 268 in place. The bearing sleeve 268 can be retained on the support beam 266 by an end cap 270 (FIG. 50) or similar fastening device at the rear end and the front end of the support beam 266. The front end of the bearing sleeve 268 can abut against a stop, such as the front wall of the trailer. Thus, the bearing sleeve 268 can extend along substantially the entire length of the support beam 266. As shown in FIG. 47, the slats 30 have an inner profile that is complementary to at least a portion of the outer profile of the bearing sleeve 268 to help mate the slat 30 to the bearing sleeve 268 (and thus the support beam 266). One side of the slat 30 can have a channel 267 and the other side of the slat 30 can have a groove 269. The slats 30 are positioned such that the channel 267 of one slat faces the groove 269 of the adjacent slat 30. A flexible member 271 has one end 273 configured to engage the channel 267 and another end 275 configured to extend into the groove 269. The flexible member 271 helps reduce or prevent debris from falling through the gap between adjacent slats 30. For example, the bearing sleeves 268 and slats 30 can be installed and then the flexible member 271 slid into the channel 267 and groove 269 at the rear of the conveyor and pushed forward to the front of the conveyor. An end cap 270 can be attached at the rear end of the conveyor to keep the bearing sleeves 268 and flexible members 271 from sliding out of the deck assembly 264.

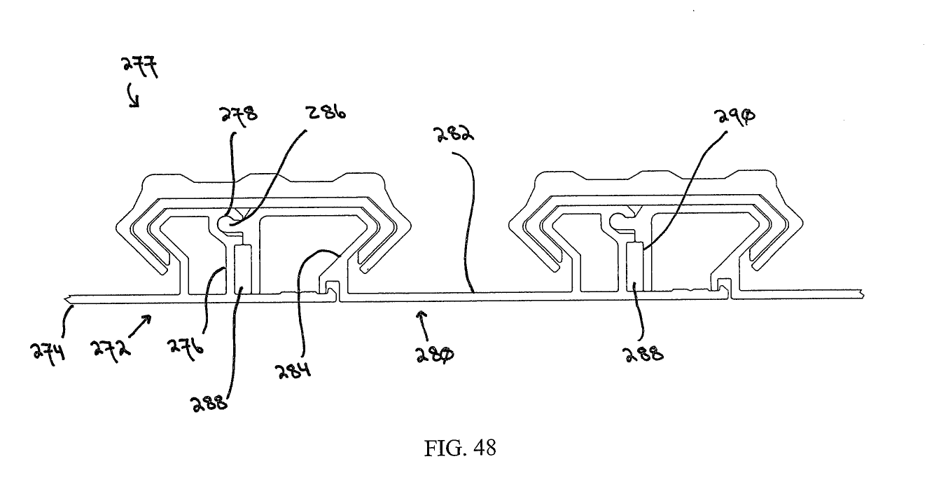

Another deck assembly 277 is shown in FIG. 48. This deck assembly 277 is particularly useful for leak-free systems to prevent debris from dropping onto the roadway through the bottom of the trailer. In this configuration, a non-porous pan may be installed in the trailer or a leak-free deck can be formed as the deck assembly is formed. The support beams can be formed by adjacent and interconnecting support beam members extending laterally along the floor of the trailer. One support beam member 272 (left side in FIG. 48) has a base 274 and a support element 276 extending upwardly therefrom. The support element 276 has a notch or groove 278 along an inner side. The second support beam member 280 (right side in FIG. 48) also includes a base 282 with an upwardly extending support element 284 having an extension or projection 286 configured to engage the groove 278 on the first support element 276 to connect the adjacent support beam members 272, 280 together. This arrangement reduces the number of bolts or connectors needed to form the deck assembly since adjacent pieces interconnect with each other and do not have to be individually secured to the deck of the trailer. An elastomeric member, such as an elongated polymeric strip 288, can be positioned in a channel 290 formed between the first support element 276 and second support element 284 to seal the support elements. In one embodiment, the adjacent support beam members 272, 280 themselves form a leak-free seal on the trailer floor and the separate pan may not be needed.

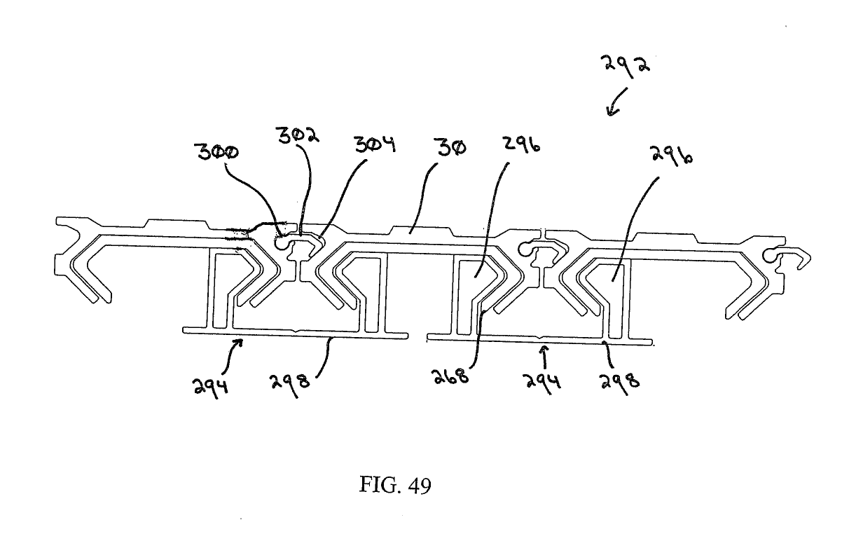

FIG. 49 shows another leak resistant deck assembly 292 having adjacent support beam members 294 that can be interlocked and interconnected. Each support beam member 294 has a pair of inwardly facing profiled supports 296 extending upwardly from a base 298. The bearing sleeve 268 is positioned over the profiles of adjacent support beam members 294 and the slat 30 is positioned to engage the bearing sleeve 268. As shown in FIG. 49, each slat 30 can have a groove 300 in one side configured to accept an end of an elastomeric bearing element, such as a plastic strip 302, that extends into a receiving groove 304 on the adjacent slat 30. This provides a leak-resistant sub deck to prevent particles passing through the bottom of the trailer.

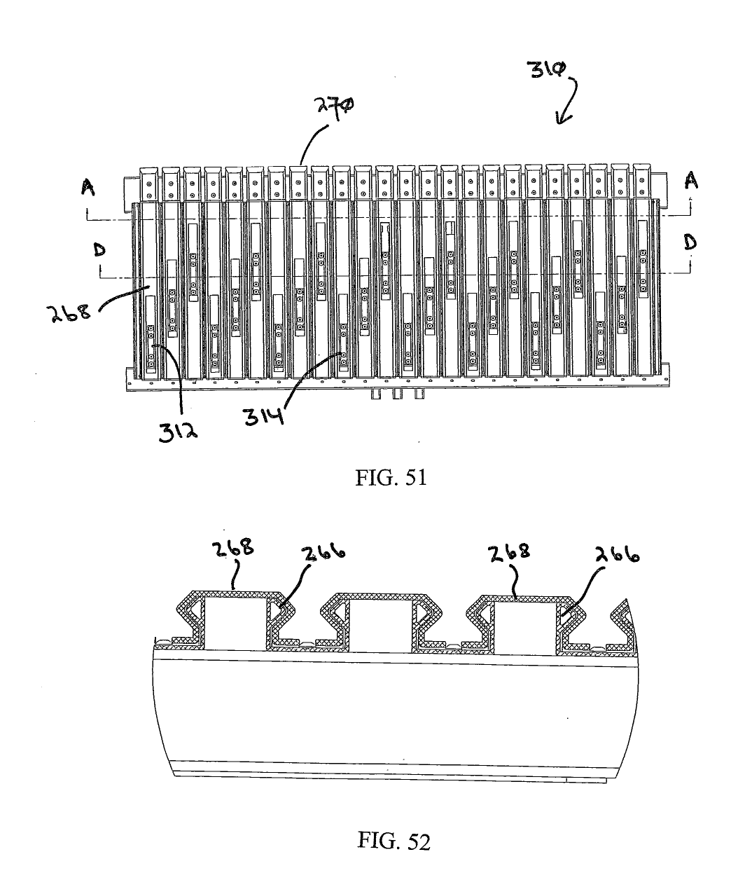

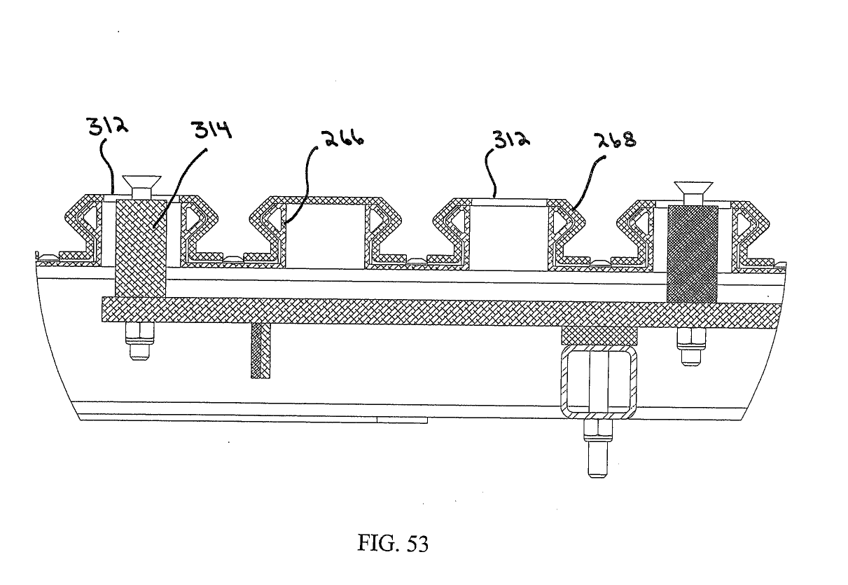

A portion of a deck assembly 310 is shown in FIGS. 50 and 51. These figures show the bearing sleeves 268 mounted on the support beams 266. An end cap 270 keeps the bearing sleeves 268 from sliding off the ends of the support beams 266. As also shown, the support beams 266 and bearing sleeves 268 include an open channel or slot through which the slats (not shown) can be connected to the attachment elements 314. FIG. 52 shows an end, sectional view along the line A-A of FIG. 51 showing the bearing sleeves 268 on the support beams 266. FIG. 53 is an end sectional view along the line D-D of FIG. 51 through the slots 312 of the deck assembly 310.

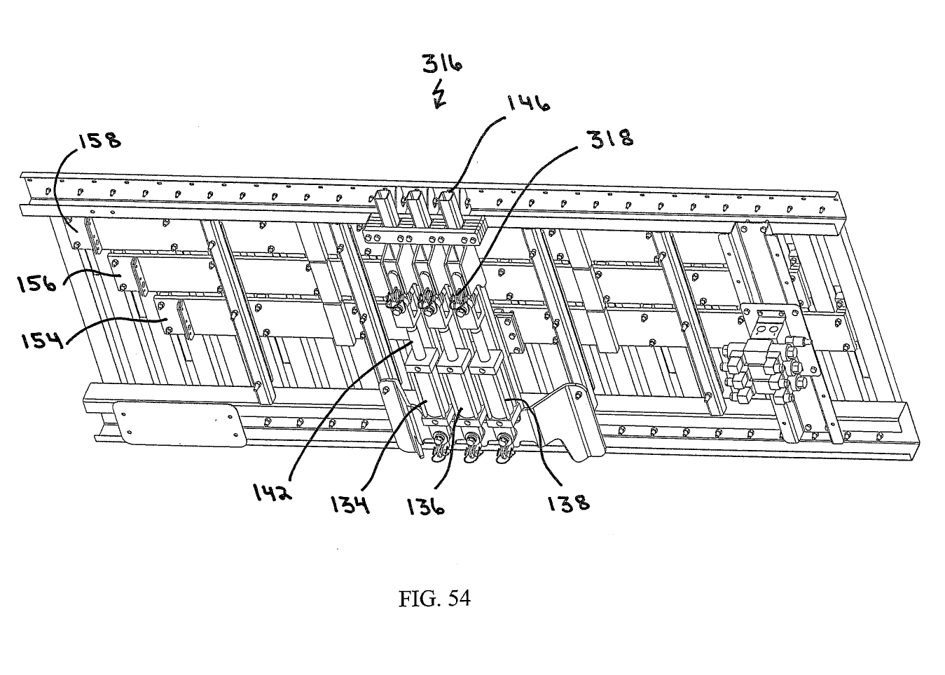

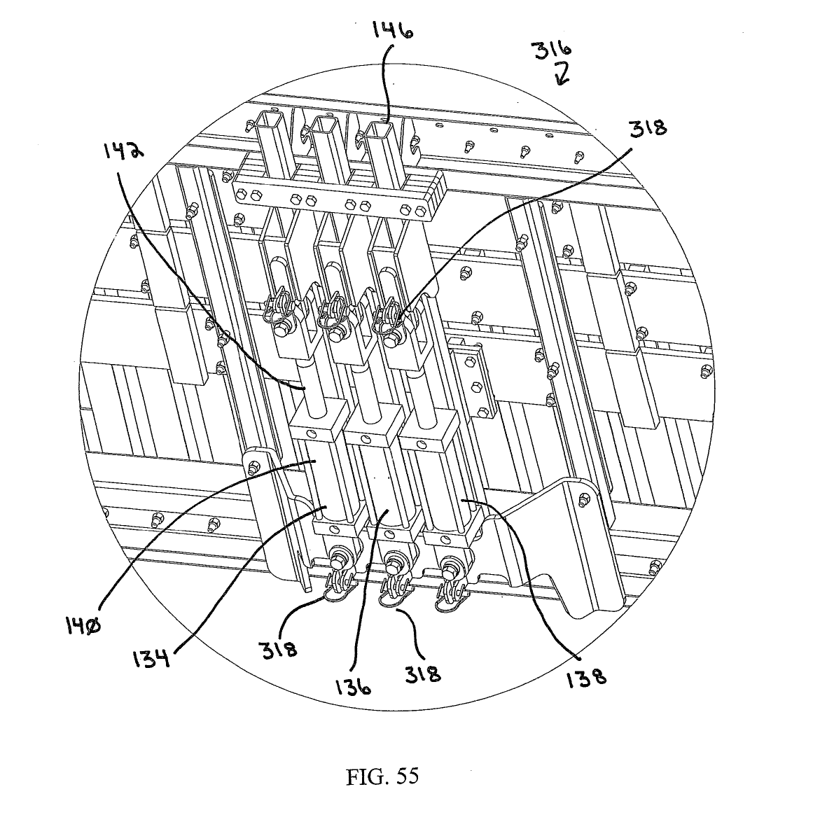

A drive assembly 316 is shown in FIGS. 54 and 55. The drive assembly 316 is similar to the drive assembly 132 described above and includes three pistons 134-138 attached to cross-beams 154-158, as described above. In this particular embodiment, the cylinders 140 are attached to the frame via a quick release coupling 318, such as a peg and lock coupling, as shown in FIG. 55. The piston rods 142 are also connected to the linear members 146 by quick release couplings 318.

It will be readily appreciated by those skilled in the art that modifications may be made to the invention without departing from the concepts disclosed in the foregoing description. As will be appreciated by one skilled in the art, the above exemplary embodiments are not mutually exclusive. That is, components or concepts from one embodiment can be substituted or incorporated into other conveyor embodiments. For example, but not limited to, the control box, controller, and side-mounted hydraulic valve assembly can be utilized in any of the embodiments. Accordingly, the particular embodiments described in detail herein are illustrative only and are not limiting to the scope of the invention, which is to be given the full breadth of the appended claims and any and all equivalents thereof.

The invention claimed is:

1. A reciprocating slat conveyor, comprising:
a plurality of slats arranged in a plurality of slat sets, with each slat having a receiving element;
a cross-beam assembly connected to the slats, wherein the cross-beam assembly includes a plurality of linear members, with one cross-beam connected to at least one linear member, wherein each cross-beam includes a plurality of connecting elements configured to engage the receiving elements on the slats;
a plurality of bearing guides configured to guide the linear members; and
an under-mount drive assembly comprising a plurality of cylinders having piston rods, with each piston rod connected to a linear member by a non-alignment critical connector.

2. The assembly of claim 1, wherein the slats are slidably engaged with plastic bearing elements and the bearing elements include a slot through which the slat receiving elements are connected to the cross-beam connecting elements.

3. The assembly of claim 1, including a position rod connected to at least one cross-beam, with the position rod including a metal member configured to interact with at least one proximity sensor.

4. The assembly of claim 1, wherein the cylinders are connected to a timer device to control operation of the cylinders.

5. The assembly of claim 1, wherein each cross-beam is connected to one cylinder.

6. The assembly of claim 1, wherein each cross-beam is connected to at least two cylinders.

7. The assembly of claim 1, including a position rod connected to each cross-beam, with the position rod including a metal member configured to interact with at least one proximity sensor to signal a stroke position of the hydraulic cylinder connected to the cross-beam.

8. The assembly of claim 1, wherein each cylinder is connected to a vehicle frame by a non-alignment critical connector.

9. The assembly of claim 4, wherein the timer device is adjustable to vary the stroke time of the piston rods.

10. The assembly of claim 8, wherein the connector comprises a substantially “U”-shaped member.

11. The assembly of claim 1, wherein the linear members are substantially rectangular hollow metal tubes.

12. The assembly of claim 8, wherein the non-alignment critical connector includes a quick release coupling.

13. A reciprocating slat conveyor, comprising:
a plurality of slats arranged in a plurality of slat sets, with each slat having a receiving element;
a cross-beam assembly connected to the slats, wherein the cross-beam assembly includes a plurality of linear members, with one cross-beam connected to at least one linear member, wherein each cross-beam includes a plurality of connecting elements configured to engage the receiving elements on the slats, wherein the slats are slidably engaged with plastic bearing elements and the bearing elements include a slot through which the slat receiving elements are connected to the cross-beam connecting elements;
a plurality of bearing guides configured to guide the linear members; and
an under-mount drive assembly comprising a plurality of hydraulic cylinders, wherein a front of each cylinder is connected to a vehicle frame by a non-alignment critical connector, and wherein each piston rod is connected to a linear member by a non-alignment critical connector.

14. The assembly of claim 13, wherein the hydraulic cylinders are connected to a timer device to control operation of the cylinders.

15. The assembly of claim 13, including a position rod connected to at least one cross-beam, with the position rod including a metal member configured to interact with a proximity sensor to signal a stroke position of the hydraulic cylinder connected to the cross-beam.

16. The assembly of claim 13, wherein the non-alignment critical connectors comprise substantially “U”-shaped members.

17. The assembly of claim 16, wherein the non-alignment critical connectors include a quick release coupling.

18. A deck assembly, comprising:
longitudinal support beams, with each support beam having an exterior profile;
plastic bearing sleeves, with each bearing sleeve having an interior profile complementary to at least a portion of the exterior profile of the support beam and slidable along the support beam; and
slats having an interior profile complementary to at least a portion of the outer profile of the bearing sleeve and configured to slide along the bearing sleeve, wherein each slat has a channel on one side and a groove on an opposite side, wherein a flexible member has a first end that engages the channel on one slat and a second end that extends into the groove on an adjacent slat, and wherein the second end of the flexible member includes an angled portion that contacts an upwardly facing surface of the groove.
